(19) United States
(12) Patent Application Publication
(10) Pub. No.: US 2022/0159996 A1
(43) Pub. Date: May 26, 2022

(54) A BREAD-BASED BEVERAGE

(71) Applicant: NATIONAL UNIVERSITY OF SINGAPORE, Singapore (SG)

(72) Inventors: Shao Quan LIU, Singapore (SG); Mingzhan TOH, Singapore (SG); Thuy Linh NGUYEN, Singapore (SG)

(73) Assignee: NATIONAL UNIVERSITY OF SINGAPORE, Singapore (SG)

(21) Appl. No.: 17/600,796

(22) PCT Filed: Apr. 1, 2020
(86) PCT No.: PCT/SG2020/050200

§ 371 Date: Oct. 1, 2021

(30) Foreign Application Priority Data
Apr. 2, 2019 (SG) 10 2019 02948Y

(51) Int. Cl. A23L 2/38; A23L 33/135; A21D 17/00; A23L 33/14

(52) U.S. Cl. CPC A23L 2/382; A23L 33/135; A21D 17/002; A23Y 2300/49; A23V 2002/00; A23Y 2220/73; A23L 33/14

(57) ABSTRACT

The invention relates to a bread-based beverage comprising probiotics selected from Lactobacilli, Bifidobacteria, Saccharomyces yeast, or a combination thereof, wherein the probiotics has a live probiotic cell count of >5.0 log CFU/mL. There is also provided a method of preparing the bread-based beverage thereof, comprising mixing bread with water to form a mixture; adding probiotics to the mixture to form an inoculated mixture and fermenting the inoculated mixture to form the beverage.

### TECHNICAL FIELD

The present invention relates to a bread-based beverage and a method of preparing the same.

### BACKGROUND

Food wastage is a growing global concern, with up to one third of all food produced globally being discarded before consumption. Among the different types of food waste, bread is one of the most wasted items. The majority of bread wastage comes from either household wastes or market surplus.

To tackle the issue of high bread wastage, many technologies have been explored on the use of waste bread in various applications such as processing into animal feed or biovalorisation applications to produce industrial or consumer goods through fermentation processes. However, each of the existing technologies face at least one of the following limitations: the application has low added value, the application is only applicable for industrial bread waste and not household bread waste, the application still leaves behind substantial solid bread waste.

### SUMMARY OF THE INVENTION

The present invention seeks to address these problems, and/or to provide a bread-based beverage using waste bread, as well as a method of preparing the beverage without generating any waste.

According to a first aspect, the present invention provides a bread-based beverage comprising probiotics, wherein the probiotics has a live probiotic cell count of ≥5.0 log CFU/mL. The beverage may be a fermented beverage.

According to a particular aspect, after 6 weeks of storage, the probiotics comprised in the beverage may have a live probiotic cell count of ≥5.0 log CFU/mL.

The probiotics comprised in the beverage may be any suitable probiotic. For example, the probiotics may be, but not limited to, a probiotic yeast, a probiotic bacteria, or a combination thereof. For example, the probiotics may comprise, but is not limited to, lactobacilli, bifidobacteria, Saccharomyces yeast, or a combination thereof. In particular, the probiotics may comprise, but is not limited to, Lactobacillus (Lb.) rhamnosus, Saccharomyces (S.) cerevisiae, Bifidobacterium (B.) lactis, or a combination thereof.

The beverage may further comprise an additive. The additive may be any suitable additive. For example, the additive may be, but not limited to, a sweetener, a stabilizer, a flavouring, or a combination thereof.

According to a second aspect, the present invention provides a method of preparing a bread-based beverage comprising probiotics having a live cell count of ≥5.0 log CFU/mL, the method comprising:
mixing bread with water to form a mixture;
adding probiotics to the mixture to form an inoculated mixture; and
fermenting the inoculated mixture to form the beverage.

The method according to the present invention may be a zero-waste method.

According to a particular aspect, the mixing may be by any suitable means. For example, the mixing may comprise homogenising the mixture.

The mixture may comprise a suitable amount of water and bread. In particular, the concentration of bread in the mixture may be 0.5-10.0 wt % based on total solid content of the mixture.

The bread comprised in the mixture may be any suitable bread. For example, the bread may have suitable moisture content. According to a particular aspect, the bread may have a moisture content of 30-45 wt %.

The adding may comprise adding any suitable probiotics to the mixture. For example, the probiotics may comprise, but is not limited to: a probiotic yeast, a probiotic bacteria, or a combination thereof. In particular, the probiotics may comprise, but is not limited to: lactobacilli, bifidobacteria, Saccharomyces yeast, or a combination thereof. Even more in particular, the probiotics may comprise: Lactobacillus (Lb.) rhamnosus, Saccharomyces (S.) cerevisiae, Bifidobacterium (B.) lactis, or a combination thereof.

The adding may comprise adding a suitable amount of probiotics. According to a particular aspect, the adding may comprise adding probiotics to obtain an initial probiotic live count of at least 1 log CFU/mL.

The fermenting may be under any suitable conditions. For example, the fermenting may be for a pre-determined period of time. According to a particular aspect, the pre-determined period of time may be 4-96 hours.

The fermenting may be at a pre-determined temperature. According to a particular aspect, the pre-determined temperature may be 15-45° C.

The method may further comprise adding an additive to the mixture. The additive may be any suitable additive. For example, the additive may be, but not limited to, a sweetener, a stabilizer, a flavouring, or a combination thereof.

The method may further comprise heat-treating the mixture prior to the adding probiotics. The heat-treating may be by any suitable means.

The method may further comprise cooling the mixture following the heat treating and prior to the adding probiotics.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows changes in viable cell counts of L. rhamnosus GG (FIG. 1(A)) and S. cerevisiae CNCM I-3856 (FIG. 1(B)) during 37° C. incubation in bread slurries (2.5 wt. % total solids) inoculated with mono-culture and co-culture, propagated in bread slurry. Error bars indicate standard deviations from independent experiments (n=3). “*” indicates significant differences (P<0.05) within the same time point;

FIG. 2 shows changes in pH during 37° C. incubation for bread slurries (2.5 wt. % total solids) inoculated with L. rhamnosus GG only, S. cerevisiae CNCM I-3856 only, and L. rhamnosus GG+S. cerevisiae CNCM I-3856, propagated in bread slurry. Error bars indicate standard deviations from independent experiments (n=3);

FIG. 3 shows changes in viable L. rhamnosus GG cell counts during 37° C. incubation in bread slurries (2.5 wt. % total solids) inoculated with L. rhamnosus GG only (FIG. 3(A)) and L. rhamnosus GG+S. cerevisiae CNCM I-3856 (FIG. 3(B)) propagated in bread slurry or in broths. Error bars indicate standard deviations from independent experiments (n=3). Lowercase letters indicate significant differences (P<0.05) within the same time point;

FIG. 4 shows changes in viable S. cerevisiae CNCM I-3856 cell counts during 37° C. incubation in bread slurries (2.5 wt. % total solids) inoculated with S. cerevisiae CNCM I-3856 only (FIG. 4(A)) and L. rhamnosus GG+S. cerevisiae CNCM I-3856 (FIG. 4(B)) propagated in bread slurry or in broths. Error bars indicate standard deviations from independent experiments (n=3). Lowercase letters indicate significant differences (P<0.05) within the same time point;

FIG. 5 shows changes in pH during 37° C. incubation for bread slurries (2.5 wt. % total solids) inoculated with L. rhamnosus GG only (FIG. 5(A)), S. cerevisiae CNCM I-3856 only (FIG. 5(B), and L. rhamnosus GG+S. cerevisiae CNCM I-3856 (FIG. 5(C)) propagated in bread slurry or in broths. Error bars indicate standard deviations from independent experiments (n=3). Lowercase letters indicate significant differences (P<0.05) within the same time point;

FIG. 6 shows changes in viable L. rhamnosus GG cell counts during 37° C. incubation in bread slurries inoculated with L. rhamnosus GG only (FIG. 6(A)) and L. rhamnosus GG+S. cerevisiae CNCM I-3856 (FIG. 6(B)) and made from total solid bread contents of 1.25 wt. %, 2.5 wt. %, or 5.0 wt. %. Error bars indicate standard deviations from independent experiments (n=3). Lowercase letters indicate significant differences (P<0.05) within the same time point;

FIG. 7 shows changes in viable S. cerevisiae CNCM I-3856 cell counts during 37° C. incubation in bread slurries inoculated with S. cerevisiae CNCM I-3856 only (FIG. 7(A)) and L. rhamnosus GG+S. cerevisiae CNCM I-3856 (FIG. 7(B)) and made from total solid bread contents of 1.25 wt. %, 2.5 wt. %, or 5.0 wt. %. Error bars indicate standard deviations from independent experiments (n=3). Lowercase letters indicate significant differences (P<0.05) within the same time point;

FIG. 8 shows changes in pH during 37° C. incubation for bread slurries inoculated with L. rhamnosus GG only (FIG. 8(A)), S. cerevisiae CNCM I-3856 only (FIG. 8(B), and L. rhamnosus GG+S. cerevisiae CNCM I-3856 (FIG. 8(C)) and made from total solid bread contents of 1.25 wt. %, 2.5 wt. %, or 5.0 wt. %. Error bars indicate standard deviations from independent experiments (n=3). Lowercase letters indicate significant differences (P<0.05) within the same time point;

FIG. 9 shows changes in viable L. rhamnosus GG cell counts during 37° C. incubation in bread slurries inoculated with L. rhamnosus GG only (FIG. 9(A)) and L. rhamnosus GG+S. cerevisiae CNCM I-3856 (FIG. 9(B)) and made from 5.0 wt. % total solids of Enriched White Bread, Fine Grain Wholemeal Bread, Hi Calcium Milk Bread. Error bars indicate standard deviations from independent experiments (n=3). Lowercase letters indicate significant differences (P<0.05) within the same time point;

FIG. 10 shows changes in viable S. cerevisiae CNCM I-3856 cell counts during 37° C. incubation in bread slurries inoculated with S. cerevisiae CNCM I-3856 only (FIG. 10(A)) and L. rhamnosus GG+S. cerevisiae CNCM I-3856 (FIG. 10(B)) and made from 5.0 wt. % total solids of Enriched White Bread, Fine Grain Wholemeal Bread, Hi Calcium Milk Bread. Error bars indicate standard deviations from independent experiments (n=3). Lowercase letters indicate significant differences (P<0.05) within the same time point;

FIG. 11 shows changes in pH during 37° C. incubation for bread slurries inoculated with L. rhamnosus GG only (FIG. 11(A)), S. cerevisiae CNCM I-3856 only (FIG. 11(B), and L. rhamnosus GG+S. cerevisiae CNCM I-3856 (FIG. 11(C)) and made from 5.0 wt. % total solids of Enriched White Bread, Fine Grain Wholemeal Bread, Hi Calcium Milk Bread. Error bars indicate standard deviations from independent experiments (n=3). Lowercase letters indicate significant differences (P<0.05) within the same time point;

FIG. 12 shows changes in viable L. rhamnosus GG cell counts during 37° C. incubation in bread slurries inoculated with L. rhamnosus GG only (FIG. 12(A)) and L. rhamnosus GG+S. cerevisiae CNCM I-3856 (FIG. 12(B)) and made from 5.0 wt. % total solids of Enriched White Bread without additives or with 3 wt. % sweetener+0.001 wt. % stabiliser. Error bars indicate standard deviations from independent experiments (n=3). Lowercase letters indicate significant differences (P<0.05) within the same time point. Uppercase letters indicate significant differences (P<0.05) across different time points of the same sample;

FIG. 13 shows changes in viable S. cerevisiae CNCM I-3856 cell counts during 37° C. incubation in bread slurries inoculated with S. cerevisiae CNCM I-3856 only (FIG. 13(A)) and L. rhamnosus GG+S. cerevisiae CNCM I-3856 (FIG. 13(B)) and made from 5.0 wt. % total solids of Enriched White Bread without additives or with 3 wt. % sweetener+0.001 wt. % stabiliser. Error bars indicate standard deviations from independent experiments (n=3). Lowercase letters indicate significant differences (P<0.05) within the same time point. Uppercase letters indicate significant differences (P<0.05) across different time points of the same sample;

FIG. 14 shows changes in pH during 37° C. incubation for bread slurries inoculated with L. rhamnosus GG only (FIG. 14(A)), S. cerevisiae CNCM I-3856 only (FIG. 14(B), and L. rhamnosus GG+S. cerevisiae CNCM I-3856 (FIG. 14(C)) and made from 5.0 wt. % total solids of Enriched White Bread without additives or with 3 wt. % sweetener+0.001 wt. % stabiliser. Error bars indicate standard deviations from independent experiments (n=3). Lowercase letters indicate significant differences (P<0.05) within the same time point;

FIG. 15 shows changes in viable L. rhamnosus GG cell counts during storage at 5° C. (FIG. 15(A)) and 30° C. (FIG. 15(B)) for fermented bread beverages inoculated with L. rhamnosus GG only and L. rhamnosus GG+S. cerevisiae CNCM I-3856 followed by 37° C. incubation for 16 hours. Error bars indicate standard deviations from independent experiments (n=3);

FIG. 16 shows changes in viable S. cerevisiae CNCM I-3856 cell counts during storage at 5° C. (FIG. 16(A)) and 30° C. (FIG. 16(B)) for fermented bread beverages inoculated with S. cerevisiae CNCM I-3856 only and L. rhamnosus GG+S. cerevisiae CNCM I-3856 followed by 37° C. incubation for 16 hours. Error bars indicate standard deviations from independent experiments (n=3);

FIG. 17 shows changes in pH during storage at 5° C. (FIG. 17(A)) and 30° C. (FIG. 17(B)) inoculated with L. rhamnosus GG only, S. cerevisiae CNCM I-3856 only, and L. rhamnosus GG+S. cerevisiae CNCM I-3856 followed by 37° C. incubation for 16 hours. Error bars indicate standard deviations from independent experiments (n=3);

FIG. 18 shows changes in viable L. rhamnosus GG cell counts during storage at 5° C. (FIG. 18(A)) and 30° C. (FIG. 18(B)) for fermented bread beverages inoculated with L. rhamnosus GG only and L. rhamnosus GG+S. cerevisiae CNCM I-3856 followed by 37° C. incubation for 16 hours. Error bars indicate standard deviations from independent experiments (n=3);

FIG. 19 shows changes in viable S. cerevisiae CNCM I-3856 cell counts during storage at 5° C. (FIG. 19(A)) and 30° C. (FIG. 19(B)) for fermented bread beverages inoculated with S. cerevisiae CNCM I-3856 only and L. rhamnosus GG+S. cerevisiae CNCM I-3856 followed by 37° C. incubation for 16 hours. Error bars indicate standard deviations from independent experiments (n=3);

FIG. 20 shows changes in pH during storage at 5° C. (FIG. 20(A)) and 30° C. (FIG. 20(B)) inoculated with L. rhamnosus GG only, S. cerevisiae CNCM I-3856 only, and L. rhamnosus GG+S. cerevisiae CNCM I-3856 followed by 37° C. incubation for 16 hours. Error bars indicate standard deviations from independent experiments (n=3);

FIG. 21 shows changes in viable B. lactis BB-12 cell counts during storage at 5° C. (FIG. 21 (A)) and 30° C. (FIG. 21(B)) for fermented bread beverages inoculated with B. lactis BB-12 only and B. lactis BB-12+S. cerevisiae CNCM I-3856 followed by 37° C. incubation for 24 hours. Error bars indicate standard deviations from independent experiments (n=3); and

FIG. 22 shows changes in viable S. cerevisiae CNCM I-3856 cell counts during storage at 5° C. (FIG. 22(A)) and 30° C. (FIG. 22(B)) for fermented bread beverages inoculated with B. lactis BB-12+S. cerevisiae CNCM I-3856 followed by 37° C. incubation for 24 hours. Error bars indicate standard deviations from independent experiments (n=3).

### DETAILED DESCRIPTION

As explained above, there is a need for a way of preventing food wastage, particularly bread wastage. The present invention provides a method of using waste bread and forming a functional bread-based beverage.

In general terms, the present invention provides a high value-added beverage with functional properties. For example, the beverage according to the present invention may be probiotic, parabiotic and/or postbiotic. Further, the beverage may be a non-dairy and vegan friendly beverage. The beverage of the present invention also has the advantage of having the option of being non-filtered and non-pasteurised.

According to a first aspect, the present invention provides a bread-based beverage comprising probiotics, wherein the probiotics has a live probiotic cell count of ≥5.0 log CFU/mL. The beverage of the present invention may be a fermented beverage.

For the purposes of the present invention, the term probiotics may include probiotics, parabiotics and postbiotics. In particular, probiotics may include live microorganisms which upon ingestion in certain numbers exert health benefits beyond inherent general nutrition. The health benefits delivered by probiotics may mainly be due to their ability to populate gastrointestinal tract, contributing to establishing a healthy and balanced intestinal microflora. Paraprobiotics may include inactivated cells of probiotic microorganisms that provide health benefits upon adequate consumption through several pathways such as adhesion of dead probiotic cells to intestinal cells, provisions of compounds from cell walls of dead probiotic cells, and release of metabolites by dead probiotic cells. Postbiotics may include soluble metabolites or metabolic by-products secreted by live bacteria or released after bacterial lysis that offer health benefits through bioactivity when administered in sufficient amount. Examples of such compounds include short chain fatty acids, enzymes, peptides, teichoic acids, peptidoglycan-derived muropeptides, polysaccharides, cell surface proteins, vitamins, plasmalogens, and organic acids.

A suitable amount of probiotics may be comprised in the beverage. For example, the probiotics may have a cell count of ≥5.0 log CFU/mL. According to a particular aspect, the probiotics may have a cell count of ≥6.0 log CFU/mL. Even more in particular, the probiotics may have a cell count of ≥7.0 log CFU/mL.

In particular, the probiotics comprised in the beverage may have a live cell count of 5.0-10.0 log CFU/mL, 5.5-9.5 log CFU/mL, 6.0-9.0 log CFU/mL, 6.5-8.5 log CFU/mL, 7.0-8.0 log CFU/mL. Even more in particular, the probiotics comprised in the beverage may have a live cell count of about 6.0-9.0 log CFU/m L.

The beverage may be a stable beverage even after 6 weeks of storage. For example, the probiotics comprised in the beverage may have a live probiotic cell count of ≥5.0 log CFU/mL even after 6 weeks of storage. Accordingly, it can be seen that the beverage may still confer health benefits to the consumer even after a certain period of time following the manufacture of the beverage. Thus, the beverage may have a suitable shelf-life.

The probiotics comprised in the beverage may be any suitable probiotic. For example, the probiotics may be, but not limited to, a probiotic yeast, a probiotic bacteria, or a combination thereof. According to a particular aspect, the probiotics comprised in the beverage may be at least one type of probiotic yeast. According to another particular aspect, the probiotics comprised in the beverage may be at least one type of probiotic bacteria. According to another particular aspect, the probiotics comprised in the beverage may be at least one type of probiotic yeast and at least one type of probiotic bacteria. For example, the probiotics may comprise, but is not limited to, lactobacilli, bifidobacteria, Saccharomyces yeast, or a combination thereof. In particular, the probiotics may comprise, but is not limited to, Lactobacillus (Lb.) rhamnosus, Saccharomyces (S.) cerevisiae, Bifidobacterium (B.) lactis, or a combination thereof.

The beverage may further comprise an additive. The additive may be any suitable additive. The additive may be any suitable additive for giving a more finished consumer product, for enhancing the flavour profile of the beverage and/or for enhancing the organoleptic properties of the beverage. For example, the additive may be, but not limited to, a sweetener, a stabilizer, a flavouring, or a combination thereof.

The beverage may have a suitable alcohol content. According to a particular aspect, the alcohol content of the beverage may be 0.5% by volume. According to another particular aspect, the alcohol content may be 0.5% by volume.

According to a second aspect of the present invention, there is provided a method of preparing a bread-based beverage comprising probiotics having a live cell count of ≥5.0 log CFU/mL, the method comprising:
mixing bread with water to form a mixture;
adding probiotics to the mixture to form an inoculated mixture; and
fermenting the inoculated mixture to form the beverage.

The method may be a method for forming the bread-based beverage according to the first aspect described above.

The method according to the present invention may be a zero-waste method. In other words, the method does not produce any waste and waste bread used in preparing the bread-based beverage is completely utilised in the making of the beverage.

Accordingly, the method of the present invention overcomes the problem of bread wastage and reduces food wastage, and additionally, forms a value-added and functional beverage. The method is also simple and does not involve the use of expensive solvents, making it easier to scale-up the method.

The bread used for the purposes of the present invention may be any suitable bread.

For example, the bread may comprise bread waste. In particular, the bread may comprise industrial bread waste, household bread waste, or a combination thereof.

The bread used in the method and comprised in the beverage may have suitable properties. For example, the bread may have a suitable moisture content. In particular, the bread may have a moisture content of 30-45%.

The bread may have a suitable carbohydrate content. For example, the carbohydrate content of the bread used in the method may be 20-70 g/100 g of bread.

The bread may have a suitable protein content. For example, the protein content of the bread used in the method may be 5-10 g/100 g of bread.

The mixing may comprise mixing a suitable amount of water and bread. The mixing may comprise mixing the water and bread to form a bread slurry. Any suitable amount of bread may be added to form the slurry. For example, the amount of bread may be 0.5-10.0 wt % based on total solid content of the mixture. In particular, the amount of bread added may be 1.0-8.0 wt %, 1.25-7.5 wt %, 1.5-7.0 wt %, 2.0-6.5 wt %, 2.5-6.0 wt %, 3.0-5.5 wt %, 3.5-5.0 wt %, 4.0-4.5 wt % based on the total solid content of the mixture.

According to a particular aspect, the mixing may be by any suitable means. For example, the mixing may comprise homogenising the mixture. The homogenising may be by any suitable means, such as by means of a homogeniser. In particular, the mixing may comprise homogenising the mixture to form a homogenized mixture of drinkable liquid.

The method may further comprise adding an additive to the mixture. The additive may be any suitable additive. In particular, the additive may be for enhancing the flavour profile of the beverage and/or for enhancing the organoleptic properties of the beverage. For example, the additive may be, but not limited to, a sweetener, a stabilizer, a flavouring, or a combination thereof.

According to a particular aspect, the method may further comprise heat-treating the mixture prior to the adding probiotics. For example, the heat-treating may comprise mild pasteurization or sterilisation of the mixture. The heat-treating may extend the shelf life of the beverage and may also reduce the risk of contamination during the method of forming the beverage. In particular, the heat-treating may remove undesirable microorganisms prior to the adding probiotics.

The heat-treating may be carried out under suitable conditions. For example, the heat-treating may be carried out at a temperature of about 50-150° C. In particular, the temperature may be about 80-140° C. Even more in particular, the temperature may be about 121° C.

The heat-treating may be carried out for a suitable period of time. The time for which heat-treating is carried out may depend on the temperature at which heat-treating is carried out. For example, the heat-treating may be for 3 seconds-60 minutes. In particular, the heat-treating may be for about 3 seconds-30 minutes. Even more in particular, the heat-treating may be for about 15 minutes.

The method may further comprise cooling the mixture prior to the adding probiotics, and particularly if the mixture underwent heat-treating as described above. In particular, the cooling may comprise cooling the mixture to ambient temperature, for example about 25° C.

The adding probiotics may comprise adding any suitable probiotics to the mixture. For example, the probiotics may comprise, but is not limited to: a probiotic yeast, a probiotic bacteria, or a combination thereof. In particular, the probiotics may comprise, but is not limited to: lactobacilli, bifidobacteria, Saccharomyces yeast, or a combination thereof. Even more in particular, the probiotics may comprise: Lactobacillus (L.) rhamnosus, Saccharomyces (S.) cerevisiae, Bifidobacterium (B.) lactis, or a combination thereof.

According to a particular aspect, the adding probiotics may comprise adding two or more probiotics. Each of the two or more probiotics may be of a different type of probiotics. For example, the adding probiotics may comprise adding a combination of L. rhamnosus, S. cerevisiae, and/or B. lactis. In particular, the adding probiotics may comprise adding: L. rhamnosus GG and S. cerevisiae CNCM I-3856; or S. cerevisiae CNCM I-3856 and B. lactis BB-12.

The two or more probiotics may be added simultaneously or sequentially into the mixture. According to a particular aspect, the two or more probiotics may be added sequentially. In particular, the adding probiotics may comprise adding a first probiotics to the mixture followed by adding a second or subsequent probiotics after a pre-determined period of time after the addition of the first probiotics.

According to a particular aspect, the two or more probiotics may be added to the mixture simultaneously. In particular, the first and second or subsequent probiotics are all added to the mixture at the same time.

The adding probiotics may comprise adding a suitable amount of probiotics. According to a particular aspect, the adding probiotics may comprise adding probiotics to obtain an initial probiotic live count of at least 1 log CFU/mL. For example, the amount of probiotics added may be at least 4 log CFU/mL. In particular, the amount of probiotics added may be about 5-7 log CFU/mL, 5.5-6.5 log CFU/mL, 5.7-6 log CFU/mL. Even more in particular, the amount of probiotics added may be 4.5-6.5 log CFU/mL.

The adding probiotics may comprise adding the probiotics together with a supporting non-probiotic material. The non-probiotic material may improve the growth and/or survival of the probiotics. The non-probiotic material may be, but is not limited to, S. cerevisiae EC-1118, Williopsis saturnus NCYC 22, Yarrowia lipolytica, or inactivated yeast derivatives.

The adding probiotics may be under suitable conditions. For example, the adding probiotics may be in an aseptic setup.

The method may further comprise incubating the mixture at a suitable temperature prior to the adding probiotics. In particular, the temperature may be the temperature at which the fermenting will occur. In this way, homogeneous growth of the probiotics may occur in the mixture.

The fermenting may be carried out under any suitable conditions. For example, the fermenting may be for a pre-determined period of time. The pre-determined period of time may be any suitable period of time for the purposes of the present invention. The pre-determined period of time may be dependent on the probiotics added in the adding probiotics. According to a particular aspect, the pre-determined period of time may be 4-96 hours. In particular, the pre-determined period of time may be 4-72 hours. For example, the pre-determined period of time may be 6-60 hours, 12-54 hours, 18-48 hours, 24-42 hours, 30-36 hours. Even more in particular, the pre-determined period of time may be about 16-24 hours.

The fermenting may be at a pre-determined temperature. The pre-determined temperature may be any suitable temperature for the purposes of the present invention. According to a particular aspect, the pre-determined temperature may be 15-45° C. In particular, the pre-determined temperature may be 20-40° C., 25-37° C., 30-35° C. Even more in particular, the pre-determined temperature may be about 37° C. The temperature may be changed at any point during the fermenting.

The formed beverage from the method of the present invention may have an alcohol content of ≥0.5% by volume. However, the alcohol content of the formed beverage may be adjusted. Accordingly, the method may further comprise adjusting the alcohol content of the beverage. In particular, the method may further comprise increasing the alcohol content of the beverage.

According to a particular aspect, the formed bread-based beverage may be stored at a suitable temperature following the fermentation. For example, the beverage may be stored at a temperature of ≥30° C. In particular, the beverage may be stored at a temperature of about ≥25° C. Even more in particular, the beverage may be stored at a temperature of about 1-5° C.

Having now generally described the invention, the same will be more readily understood through reference to the following embodiment which is provided by way of illustration, and is not intended to be limiting.

### EXAMPLES

Production of Bread-Based Beverages

Bread in sliced form from Gardenia (S) Pte. Ltd. (Enriched White Bread, Fine Grain Wholemeal Bread, or Hi Calcium Milk Bread) were cut into small dices and topped up with Ice Mountain mineral water (Fraser and Neave Ltd.) to total solid contents of 1.25, 2.50, or 5.00 wt. %. The mixture was homogenized using a Silverson L4RT mixer (Silverson Machines Ltd, Buckinghamshire, UK) with an Emulsor Screens workhead at 7000 rpm for 15 minutes. Zero-calorie sweetener from Taikoo Sugar Refinery (erythritol—99.5 wt. %, steviol glycosides, vanilla extract) at 3 wt. % and with Kelcogel® Gellan Gum from CP Kelco at 0.001 wt. % were added to some samples of the resulting slurry. The sweeteners were added under mixing of the Silverson L4RT mixer at 3000 rpm for 1 minute followed by further blending at 5000 rpm for 10 minutes. The slurry was then sterilized at 121° C. for 15 minutes, and then cooled down to ambient temperature.

The prepared sterilized bread slurry was inoculated with either a strain of probiotic bacterium, or a strain of probiotic yeast, or both. In the case that both probiotic bacterium and probiotic yeast were inoculated into the bread slurry as co-culture, the inoculation of the two strains were done either simultaneously or sequentially. The probiotic bacteria used in the examples were Lactobacillus rhamnosus GG and Bifidobacterium lactis BB-12. The probiotic yeast used was Saccharomyces cerevisiae CNCM I-3856. The inoculated bread slurry was then incubated in 50-mL centrifuge tubes (40 mL in each tube) at 37° C. for fermentation.

Fermentation Monitoring

pH MEASUREMENT

pH measurements were taken with a FiveEasyPlus pH meter (Mettler Toledo, Giessen, Germany).

Microbial Enumeration

L. rhamnosus GG cell counts were determined via the pour plate method using Man, Rogosa and Sharpe agar (Merck, Darmstadt, Germany) supplemented with 0.5 g/L of Natamax (Danisco A/S, Copenhagen, Denmark) as an anti-fungal agent. B. lactis BB-12 cell counts were determined via the pour plate method using Man, Rogosa and Sharpe agar (Merck, Darmstadt, Germany) supplemented with 0.5 g/L of Natamax (Danisco A/S, Copenhagen, Denmark) as an anti-fungal agent and 0.5 g/L of L-cysteine hydrochloride for oxygen removal. S. cerevisiae CNCM I-3856 cell counts were determined via the spread plate method using potato dextrose agar (Oxoid Ltd., Hampshire, UK) supplemented with 0.1 g/L of chloramphenicol (Sigma-Aldrich, St. Louis, Mo., USA) as an anti-bacterial agent.

Shelf Life Monitoring

Weekly shelf life monitoring at 5° C. storage and 30° C. storage was carried out for selected bread-based fermented beverages. Shelf life samples were monitored with weekly pH measurements and microbial enumeration. For some sets of bread-based fermented beverages, unfermented, fermented, and end-of-shelf-life fermented samples were further analysed for quantifications of sugars, organic acids, free amino acids, volatile organic compounds, and ethanol contents.

Quantification of Sugars and Organic Acids Contents

Sugars and organic acids were analysed and quantified using high performance liquid chromatography (Shimadzu, Kyoto, Japan). Sugars were separated at 30° C. using a Zorbax carbohydrate column (150×4.6 mm, Agilent, Santa Clara, Calif., USA) connected to an evaporative light scattering detector (ELSD-LT II, Shimadzu). The mobile phase was 80 vol. % acetonitrile with an isocratic flow of 1 mL/min. Detection of eluted sugars was done using an evaporative light scattering detector (ELSD-LT II, Shimadzu). Organic acids were separated at 40° C. using a Supelcogel C-610H column (Supelco, Bellefonte, Pa., USA) connected to an SPD-M20A photodiode array detector set at 210 nm (Shimadzu). The mobile phase was 0.1 vol. % H₂SO₄ with a flow rate of 0.4 mL/min.

Quantification of Free Amino Acids (FAAs) Contents

Separation of FAAs were performed using an Aracus Amino Acid Analyser (membraPure GmbH, Berlin, Germany). Separated FAAs were derivatised post-column with ninhydrin and detected with LED photometers at 570 nm and 440 nm.

Quantification of Volatile Organic Compounds (VOCs)

Identification and semi-quantification of VOCs were carried out with a headspace solid-phase micro-extraction gas chromatography—mass spectrometer/flame ionization detector (HS-SPME-GC-MS/FID). Samples (5 g) were added with 2 g of sodium chloride (NaCl) and incubated at 60° C. for 20 minutes before being subjected to HS-SPME with 85 μm carboxen/polydimethylsiloxane (CAR/PDMS) solid-phase micro-extraction fibre (Supelco, Sigma-Aldrich, Barcelona, Spain) at 60° C. for 30 minutes with 250 rpm agitation using a Combi Pal autosampler (CTC Analytics, Zwingen, Switzerland). The solid-phase micro-extraction (SPME) fiber was thermally desorbed at 250° C. for 3 minutes in the injection port of an Agilent 7890A gas chromatograph coupled to an Agilent 5975C triple-axis MS and FID. VOCs were separated with a DB-FFAP capillary column (60 m length, 0.25 mm in diameter, 0.25 μm film thickness, Agilent) and helium as the carrier gas with a flow rate of 1.2 mL/min. The oven temperature was initially held at 50° C. for 5 minutes, thereafter, increasing at 5° C./min to 230° C. and held for 30 minutes. For mass spectrometer (MS) analysis, the detector was operated in electron ionization mode (70 eV) with the ion source temperature being maintained at 230° C. Data acquisition in full scan mode was performed for m/z 25-550 at 2.78 scans/s. VOCs were identified by matching their mass spectra with the (National Institute of Standards and Technology) NIST 08 and Wiley 275 databases, as well as comparing their linear retention index (LRI) with literature data compiled in the NIST WebBook. LRI values of VOCs were derived by relating their retention time with those of C7-C40 saturated alkane standards (Sigma-Aldrich) that were analyzed with the same parameters. Semi-quantification of VOCs was done using their flame ionization detector (FID) peak areas.

Quantification of Ethanol Contents

Ethanol contents were quantified using an alcohol measuring module (Alcolyzer ME, Anton-Parr GmbH, Graz, Austria) coupled with a density meter (DMA™ 4500 M, Anton-Parr GmbH).

Data Reporting and Statistical Analysis

All reported data include the mean values and standard deviations obtained from three independent experiments (n=3). One-way analysis of variance (ANOVA) and Duncan's multiple range test with SPSS® 20.0 (SPSS Inc. Chicago, Ill.) were used for testing of significant differences.

### Example 1—Bread-Based Fermented Beverages Inoculated with Microorganisms (L. rhamnosus GG and/or S. cerevisiae CNCM I-3856) Propagated in Bread Slurry

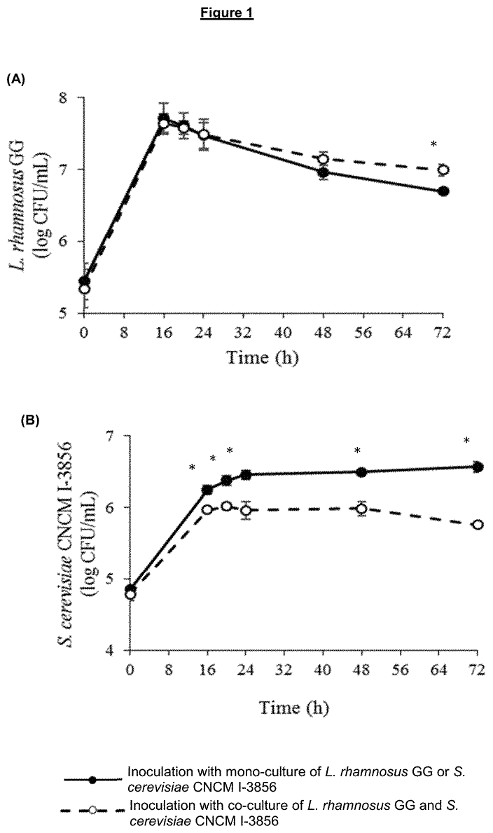

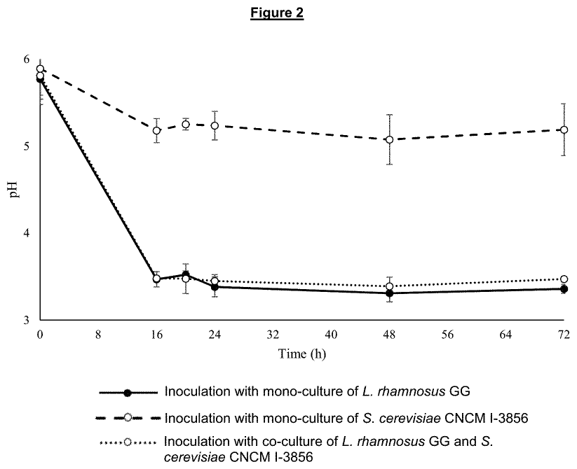

Fermentation was carried out in bread slurries made of 2.5 wt. % total bread solids, inoculated with microorganisms (L. rhamnosus GG and/or S. cerevisiae CNCM I-3856) propagated in bread slurry. FIGS. 1 and 2 shows cell counts and pH results.

As seen in FIG. 1(A), L. rhamnosus GG cell counts grew from 5.4 to 7.7 log CFU/mL within 16 hours at 37° C. for both mono-culture and co-culture. The cell counts remained stable from 16 to 24 hours, followed by significant decline (P<0.05) for both cultures at 48 hours. As seen in FIG. 1(B), for probiotic yeast, bread slurries were inoculated with 4.8 log CFU/mL of S. cerevisiae CNCM I-3856. During incubation at 37° C., viable S. cerevisiae CNCM I-3856 cell counts peaked at 6.5 log CFU/mL (20 hours) for mono-culture and at 6.0 log CFU/mL (16 hours) when co-cultured with L. rhamnosus GG. Throughout the 72 hours, viable S. cerevisiae CNCM I-3856 cell counts in mono-culture were significantly higher compared to the co-culture.

As seen in FIG. 2, after incubation at 37° C. for 16 hours, the pH of all fermented bread slurries declined from an initial value of 5.8 and remained stable at around 5.2 for S. cerevisiae CNCM I-3856 mono-culture, 3.4 for L. rhamnosus GG mono-culture, and 3.5 for co-cultured samples.

### Example 2—Bread-Based Fermented Beverages Inoculated with Microorganisms (L. rhamnosus GG and/or S. cerevisiae CNCM I-3856) Propagated in Broths

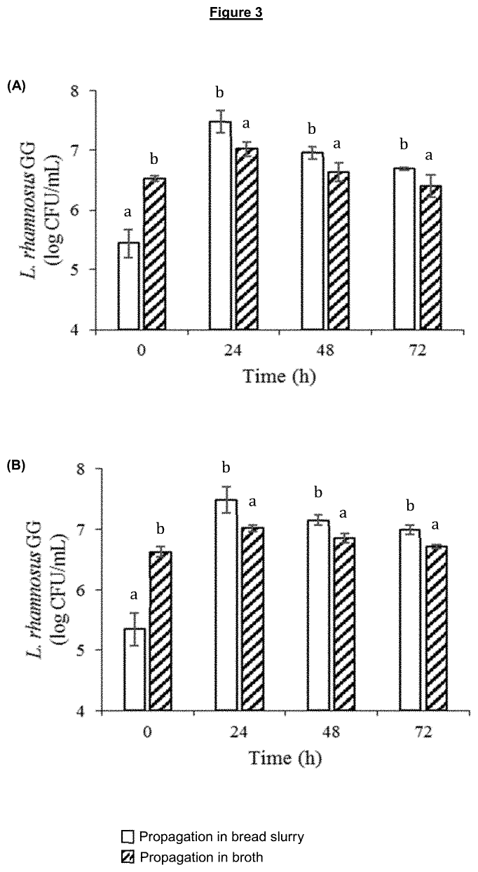

Fermentation was carried out in bread slurries made of 2.5 wt. % total bread solids, inoculated with microorganisms (L. rhamnosus GG and/or S. cerevisiae CNCM I-3856) propagated in broths. FIGS. 3, 4 and 5 show cell counts and pH results, compared against fermentation with microorganisms propagated in bread slurry (Example 1).

Similar trends in L. rhamnosus GG cell counts were observed in mono-culture, as seen in FIG. 3(A), and co-culture samples, as seen in FIG. 3(B). Bread slurry samples inoculated with microorganisms propagated in broths had significantly higher initial L. rhamnosus GG cell counts (6.6 log CFU/mL) as compared to samples inoculated with microorganisms propagated in bread slurry (5.4 log CFU/mL). However, growth of L. rhamnosus GG in the broths was significantly lower compared to growth in bread slurry. After 24 hours of incubation, when peak L. rhamnosus GG cell counts were observed in all samples, L. rhamnosus GG cell counts were 7.0 log CFU/mL in samples with microorganisms propagated in broths, compared to 7.5 log CFU/mL in samples with microorganisms propagated in bread slurry.

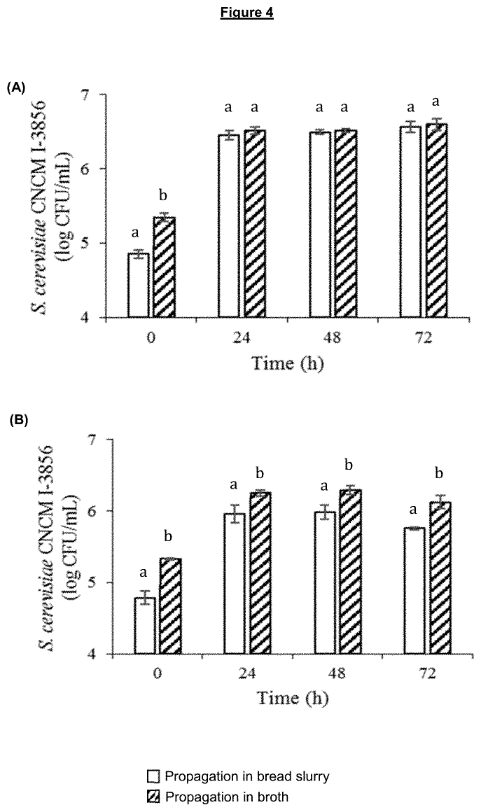

Similarly, as seen in FIG. 4, bread slurry samples inoculated with microorganisms propagated in broths also had significantly higher initial S. cerevisiae CNCM I-3856 cell counts as compared to samples inoculated with microorganisms propagated in bread slurry (5.3 log CFU/mL compared to 4.8 log CFU/mL). As seen in FIG. 4(A), for mono-culture samples, S. cerevisiae CNCM I-3856 cell counts grew to around 6.5 log CFU/mL at 24 to 72 hours of incubation for both samples with microorganisms propagated in broths and samples with microorganisms propagated in bread slurry. As seen in FIG. 4(B), for co-culture samples, as opposed to L. rhamnosus GG cell counts, peak S. cerevisiae CNCM I-3856 cell counts (24 to 48 hours) in samples with microorganisms propagated in broths were significantly higher than in samples with microorganisms propagated in bread slurry (6.3 log CFU/mL compared to 6.0 log CFU/mL).

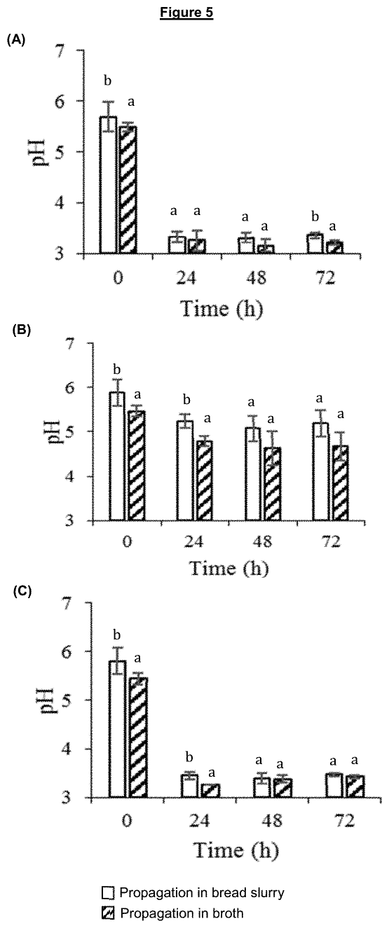

FIG. 5 shows that pH values of samples inoculated with microorganisms propagated in bread slurry and samples inoculated with microorganisms propagated in broths were comparable across mono-culture of L. rhamnosus GG (FIG. 5(A)), mono-culture of S. cerevisiae CNCM I-3856 (FIG. 5(B)), and co-culture of L. rhamnosus GG and S. cerevisiae CNCM I-3856 (FIG. 5(C)), with some slight significant differences observed, where samples inoculated with microorganisms propagated in broths had slightly lower pH compared to their counterparts.

Overall, while fermentation using microorganisms propagated in bread slurry resulted in 0.3 log CFU/mL higher peak S. cerevisiae CNCM I-3856 cell count for mono-culture, it had no effects on peak S. cerevisiae CNCM I-3856 cell count for co-culture.

Furthermore, it resulted in 0.5 log CFU/mL lower peak L. rhamnosus GG cell counts for both mono-culture and co-culture.

Subsequent fermentation examples were carried out using microorganisms propagated in bread slurry, which was favourable towards the L. rhamnosus GG cell counts.

### Example 3—Bread-Based Fermented Beverages Made from Different Bread Concentrations

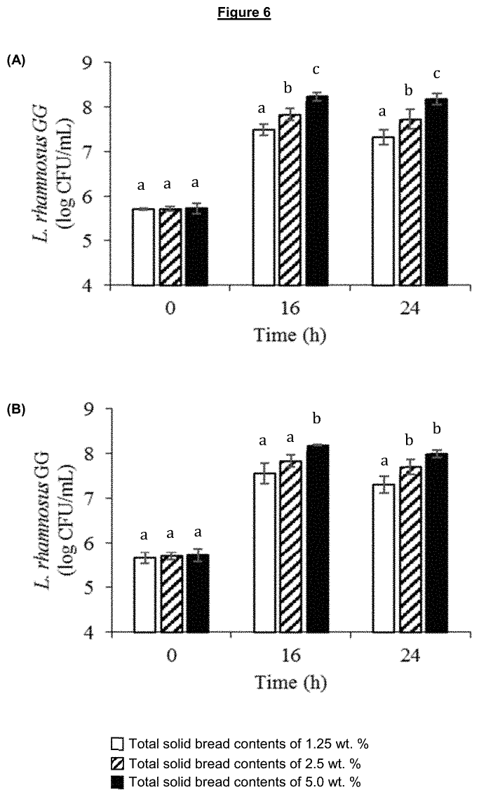

Comparisons of cell counts and pH were made between bread-based fermented beverages inoculated with microorganisms (L. rhamnosus GG and/or S. cerevisiae CNCM I-3856) of different initial bread concentrations, namely 1.25 wt. %, 2.5 wt. %, and 5.0 wt. % total solids. FIGS. 6, 7, and 8 show the comparison results.

As seen in FIG. 6, for L. rhamnosus GG, all bread slurries were inoculated with 5.7 log CFU/mL of L. rhamnosus GG. After 16 hours, L. rhamnosus GG cell counts were at their peak with significant differences observed between the different bread concentrations. The extent of cell growth significantly increased with increasing bread contents. FIG. 6(A) shows that, for mono-culture samples, peak L. rhamnosus GG cell counts (16 hours of incubation) in samples of 1.25 wt. %, 2.5 wt. %, and 5.0 wt. % initial solid bread contents were 7.5, 7.8, and 8.2 log CFU/mL respectively. FIG. 6(B) shows that, for co-culture samples, peak L. rhamnosus GG cell counts (16 hours of incubation) in samples of 1.25 wt. %, 2.5 wt. %, and 5.0 wt. % initial solid bread contents were 7.6, 7.8, and 8.2 log CFU/mL respectively.

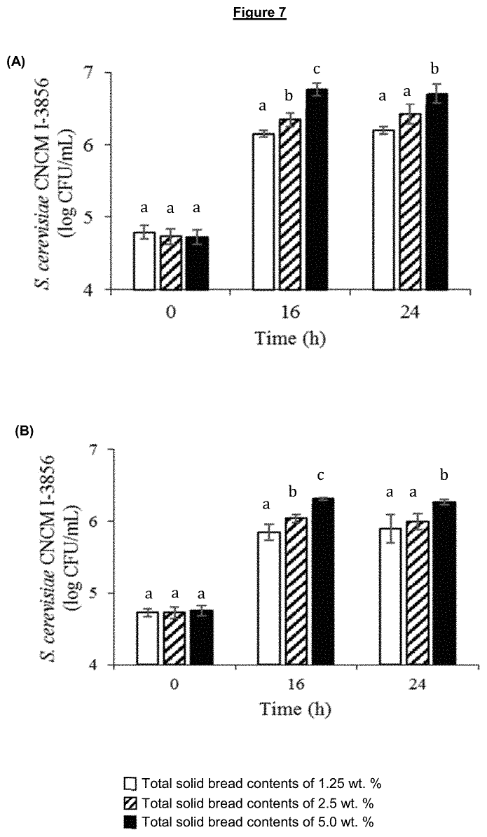

FIG. 7 shows similar trends for S. cerevisiae CNCM I-3856. All samples were inoculated with 4.7 log CFU/mL of S. cerevisiae CNCM I-3856. FIG. 7(A) shows that, for mono-culture, peak S. cerevisiae CNCM I-3856 cell counts (16 hours of incubation) in samples of 1.25 wt. %, 2.5 wt. %, 5.0 wt. % initial solid bread contents were 6.2, 6.4, and 6.8 log CFU/mL respectively. FIG. 7(B) shows that, for co-culture, peak S. cerevisiae CNCM I-3856 cell counts (16 hours of incubation) in samples of 1.25 wt. %, 2.5 wt. %, 5.0 wt. % initial solid bread contents were 5.9, 6.1, and 6.3 log CFU/mL respectively. It was also observed that higher viable S. cerevisiae CNCM I-3856 cell counts were obtained in mono-culture samples compared to co-culture samples.

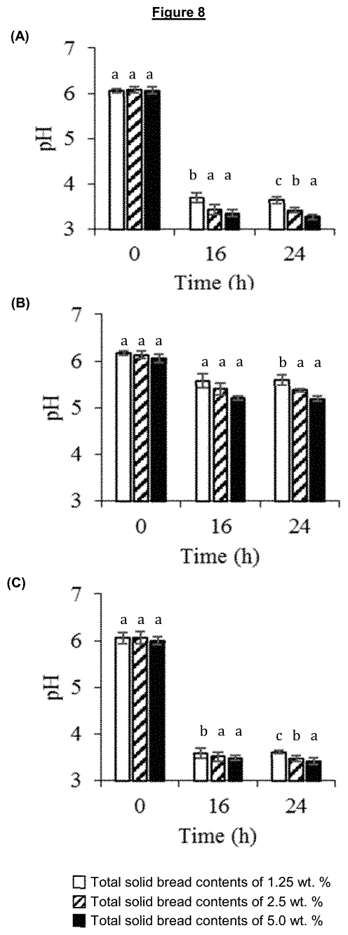

FIG. 8 shows that pH changes in samples of different initial bread contents were comparable across mono-culture of L. rhamnosus GG (FIG. 8(A)), mono-culture of S. cerevisiae CNCM I-3856 (FIG. 8(B)), and co-culture of L. rhamnosus GG and S. cerevisiae CNCM I-3856 (FIG. 8(C)). In some instances, the extent of pH drops in samples slightly increased with increasing initial bread contents.

Overall, higher bread concentrations resulted in better growth of the microorganisms and higher peak cell counts, as expected due to the higher nutrients supplied to the microorganisms. Among the investigated bread concentrations, fermentation in bread slurry of 5.0 wt. % initial total bread solids yielded highest viable cell counts for both L. rhamnosus GG and S. cerevisiae CNCM I-3856. Thus, 5.0 wt. % initial total bread solids was used in subsequent fermentation examples.

### Example 4—Bread-Based Fermented Beverages from Sequential Fermentation with L. rhamnosus GG and S. cerevisiae CNCM I-3856

Sequential fermentation was carried out where L. rhamnosus GG was inoculated into the bread slurry 24 hours after S. cerevisiae CNCM I-3856 inoculation and incubation, allowing time for S. cerevisiae CNCM I-3856 to grow in the medium before competition by L. rhamnosus GG was introduced. Table 1 shows the results on peak cell counts of sequential inoculation, and prior results on peak cell counts of mono-culture and co-culture.

TABLE 1
Peak viable cell counts in fermented samples with different
inoculation methods.
Peak viable cell counts (log CFU/mL)

| | | Simultaneous | Sequential |
|---|---|---|---|
| | Mono-culture | inoculation | inoculation |
| | (16 hours) | (16 hours) | (48 hours) |
| L. rhamnosus GG | 8.24 ± 0.09^{b} | 8.19 ± 0.01^{b} | 7.12 ± 0.05^{a} |
| S. cerevisiae | 6.76 ± 0.09^{b} | 6.32 ± 0.02^{a} | 6.70 ± 0.08^{b} |
| CNCM I-3856 | | | |

Results reported as mean values and standard deviations from independent experiments (n = 3).
Mean values in the same row with different lowercase letters are significantly different (P < 0.05).

As shown in Table 1, peak S. cerevisiae CNCM I-3856 cell counts obtained from sequential fermentation was 6.70 log CFU/mL, which was almost the same as mono-culture fermentation, and was 0.38 log CFU/mL higher than co-culture with simultaneous inoculation. However, peak L. rhamnosus GG cell counts were greatly reduced with sequential fermentation, with 7.12 log CFU/mL compared to 8.19 log CFU/mL in simultaneous co-culture fermentation (1.07 log CFU/mL lower). The lower peak L. rhamnosus GG cell count obtained from sequential fermentation as compared to simultaneous inoculation can be attributed reduction in the ability of L. rhamnosus GG to compete and populate in a medium already rich in S. cerevisiae CNCM I-3856 cells. In addition, after incubation with yeast for 24 hours, nutrients in the bread slurry might have been depleted and there was no longer much nutrient to support the later-inoculated L. rhamnosus GG.

Overall, with compromise in L. rhamnosus GG cell counts greater than gain in viable S. cerevisiae CNCM I-3856 cell counts, sequential fermentation was not further explored.

### Example 5—Feasibility of Fermentation on Various Bread Types

Fermentation feasibilities on various bread types were investigated. Comparisons were made between samples made from 5.0 wt. % total solids of Enriched White Bread, Fine Grain Wholemeal Bread, and Hi Calcium Milk Bread (Gardenia). Nutritional information of the bread variants is presented in Table 2.

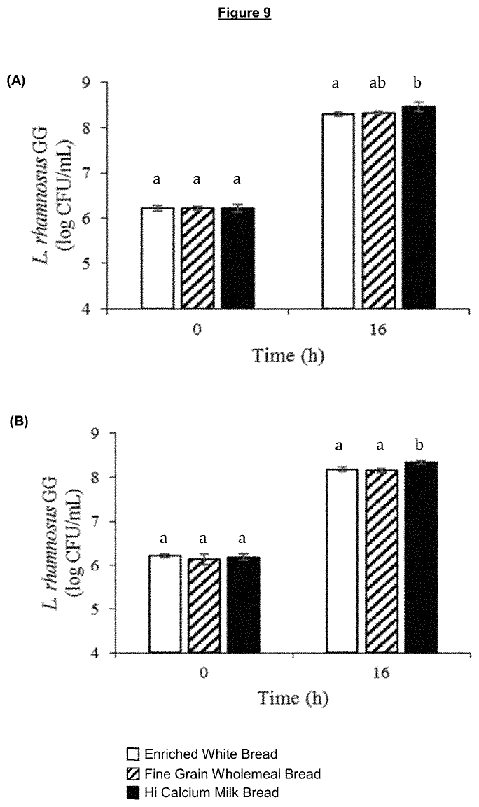

Cell counts and pH results from fermentation with L. rhamnosus GG and S. cerevisiae CNCM I-3856 are shown in FIGS. 9, 10, and 11.

For L. rhamnosus GG fermented samples, all bread slurries were inoculated with 6.2 log CFU/mL of L. rhamnosus GG. As seen in FIG. 9(A), for mono-culture, L. rhamnosus GG cell counts increased to 8.3, 8.3, and 8.5 log CFU/mL for samples made from Enriched White Bread, Fine Grain Wholemeal Bread, and Hi Calcium Milk Bread respectively after 16 hours of incubation at 37° C. As seen in FIG. 9(B), for co-culture, L. rhamnosus GG cell counts increased to 8.2, 8.2, and 8.3 log CFU/mL for samples made from Enriched White Bread, Fine Grain Wholemeal Bread, and Hi Calcium Milk Bread respectively after 16 hours at 37° C. Overall, L. rhamnosus GG growth in Fine Grain Wholemeal Bread samples after 16 hours was comparable to Enriched White Bread samples. On the other hand, L. rhamnosus GG growth in Hi Calcium Milk Bread samples after 16 hours was statistically significantly higher than in the other two bread types, likely due to presence of lutein and calcium.

TABLE 2
Nutritional information of bread variants used. Adapted from
packaging of bread loafs (Gardenia).

| | Enriched | Fine Grain | Hi Calcium |
|---|---|---|---|
| | White | Wholemeal | Milk |
| | Bread | Bread | Bread |
| Energy (kcal/100 g) | 263 | 223 | 252 |
| Protein (g/100 g) | 9.9 | 12.1 | 10.3 |
| Total fat (g/100 g) | 1.9 | 2.7 | 1.5 |
| Saturated fat (g/100 g) | 0.9 | 1.2 | 0.8 |
| Trans fat (g/100 g) | 0.0 | 0.0 | 0.0 |
| Cholesterol (mg/100 g) | 0 | 0 | 0 |
| Carbohydrates (g/100 g) | 54.7 | 38.0 | 53.3 |
| Total sugar | 3.7 | 4.7 | N/A |
| Dietary fibre (g/100 g) | 2.5 | 5.3 | 3.0 |
| Sodium (mg/100 g) | 438 | 274 | 430 |
| Vitamin B1 (mg/100 g) | 0.77 | 0.5 | 0.7 |
| Vitamin B2 (mg/100 g) | 0.48 | 0.3 | 0.4 |
| Vitamin B3 (mg/100 g) | 5.06 | 3.1 | 5.1 |
| Vitamin D3 (μg/100 g) | N/A | N/A | 1.22 |
| Lutein (μg/100 g) | N/A | N/A | 80 |
| Calcium (mg/100 g) | 171.08 | 240.0 | 362 |
| Iron (mg/100 g) | 4.53 | 4.8 | 4.7 |

N/A = Not Available (value not declared on packaging)

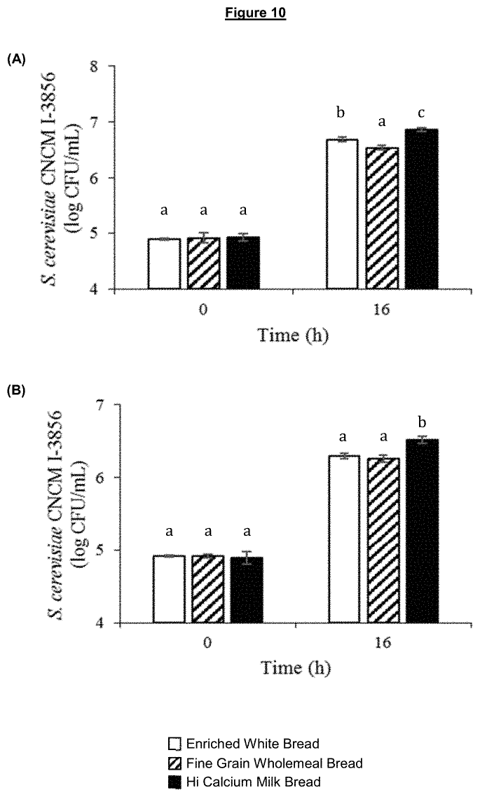

For yeast fermented samples, all bread slurries were inoculated with 4.9 log CFU/mL of S. cerevisiae CNCM I-3856. As seen in FIG. 10(A), for mono-culture, S. cerevisiae CNCM I-3856 cell counts increased to 6.7, 6.5, and 6.9 log CFU/mL for samples made from Enriched White Bread, Fine Grain Wholemeal Bread, and Hi Calcium Milk Bread respectively after 16 hours. As seen in FIG. 10(B), for co-culture, S. cerevisiae CNCM I-3856 cell counts increased to 6.3, 6.3, and 6.5 log CFU/mL for samples made from Enriched White Bread, Fine Grain Wholemeal Bread, and Hi Calcium Milk Bread respectively after 16 hours. For mono-culture, growth of S. cerevisiae CNCM I-3856 cells in Fine Grain Wholemeal Bread samples was significantly lower than in Enriched White Bread samples. For both mono-culture and co-culture, S. cerevisiae CNCM I-3856 cell growth in Hi Calcium Milk Bread samples were statistically significantly higher than in the other two bread types, likely due to the presence of lutein and calcium.

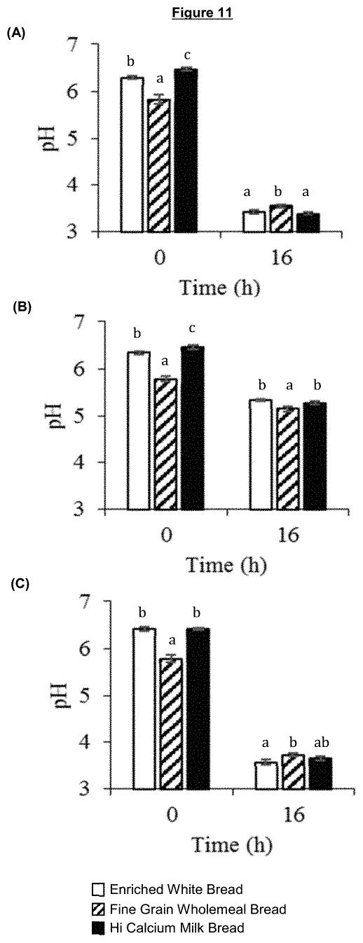

FIG. 11 shows slight variations in pH changes in samples made from different bread variants, across mono-culture of L. rhamnosus GG (FIG. 11(A)), mono-culture of S. cerevisiae CNCM I-3856 (FIG. 11(B)), and co-culture of L. rhamnosus GG and S. cerevisiae CNCM I-3856 (FIG. 11(C)).

Overall, it was shown that production of probiotic bread beverages was feasible on various types of bread, as it relied on the same mechanism of the bread providing nutrients for microbial fermentation. Slight differences in cell counts and pH were observed from fermented bread-based beverages made from different types of bread, due to the slight differences in the different bread matrices.

### Example 6—Addition of Sweetener and Stabilizer

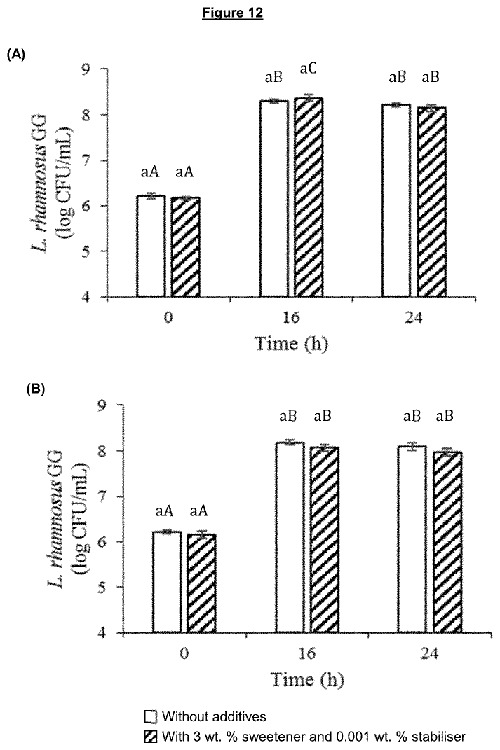

As the use of additives such as sweeteners and stabilizers is important to enhance the organoleptic properties of the final beverage products, the effects of sweetener and stabilizer addition on sample fermentation were investigated. The sweetener used was from Taikoo Sugar Refinery (erythritol—99.5 wt. %, steviol glycosides, vanilla extract). The stabilizer used was Kelcogel® Gellan Gum from CP Kelco. FIGS. 12, 13, and 14 show the cell counts and pH results, compared against results obtained when no additives were used.

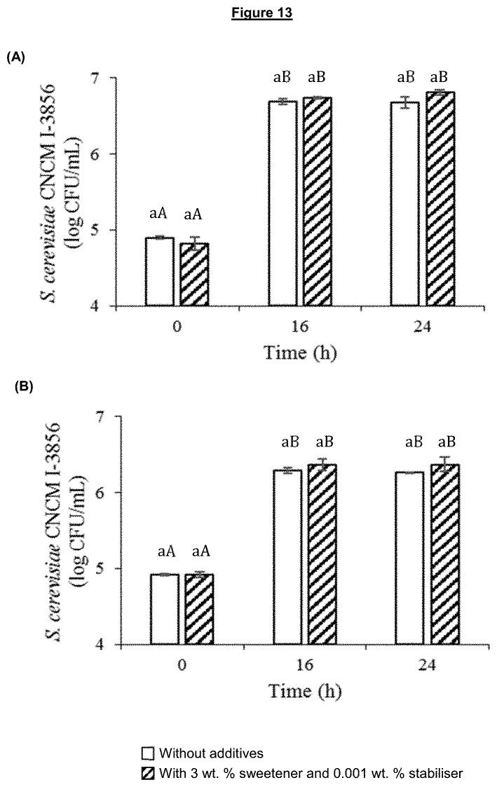

As seen in FIGS. 12 and 13, no differences in L. rhamnosus GG and S. cerevisiae CNCM I-3856 cell counts were observed between samples with and without additives. Peak cell counts for all samples were observed after 16 hours of incubation at 37° C. For samples supplemented with additives, peak L. rhamnosus GG cell counts were 8.4 log CFU/mL for mono-culture (FIG. 12(A)) and 8.1 log CFU/mL for co-culture (FIG. 12(B)) samples. For samples supplemented with additives, peak S. cerevisiae CNCM I-3856 cell counts were 6.7 log CFU/mL for mono-culture (FIG. 13(A)) and 6.4 log CFU/mL for co-culture (FIG. 13(B)) samples.

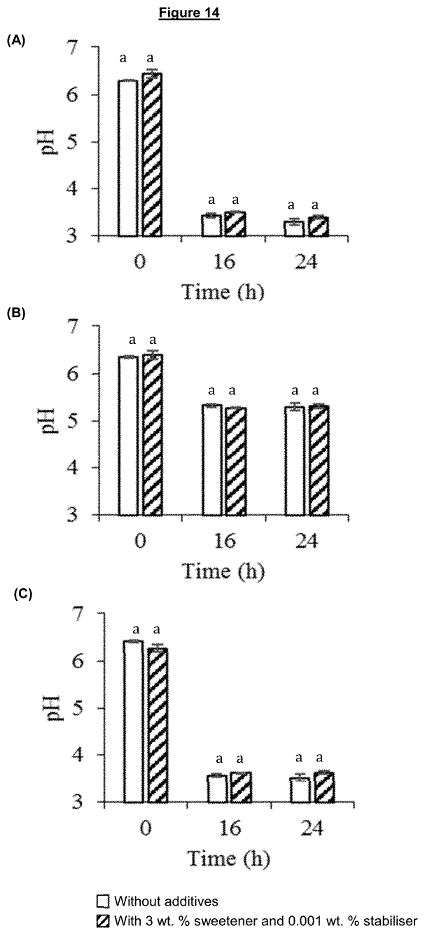

As seen in FIG. 14, no differences in pH were observed between samples with and without additives, across mono-culture of L. rhamnosus GG (FIG. 14(A)), mono-culture of S. cerevisiae CNCM I-3856 (FIG. 14(B)), and co-culture of L. rhamnosus GG and S. cerevisiae CNCM I-3856 (FIG. 14(C)).

Overall, the addition of 3 wt. % Taikoo sweetener and 0.001 wt. % Kelcogel® Gellan Gum did not affect viable cell counts and pH of the samples for the time duration investigated as expected, since the additives were not fermentable. In addition, qualitative observations were made that the addition of 3 wt. % Taikoo sweetener enhanced the taste of the samples, especially samples fermented with L. rhamnosus GG (mono-culture and co-culture) which had high levels of acidity. Furthermore, the addition of 0.001 wt. % Kelcogel® Gellan Gum delayed sedimentation of the samples for at least 1 week.

### Example 7—Shelf Life Study (6 Weeks, on Bread-Based Beverages Fermented with L. rhamnosus GG and/or S. cerevisiae CNCM I-3856)

Shelf life monitoring for a duration of 6 weeks was carried out at 5° C. and 30° C. storage for bread-based fermented beverages made with 5.00 wt. % solid Gardenia Enriched White Bread and added with 3 wt. % Taikoo sweetener and 0.001 wt. % Kelcogel® Gellan Gum. Samples were inoculated with either L. rhamnosus GG mono-culture, S. cerevisiae CNCM I-3856 mono-culture, or co-culture of the two aforementioned strains, and incubated at 37° C. for 16 hours before being transferred to storage.

(a) Viable Cell Counts and pH

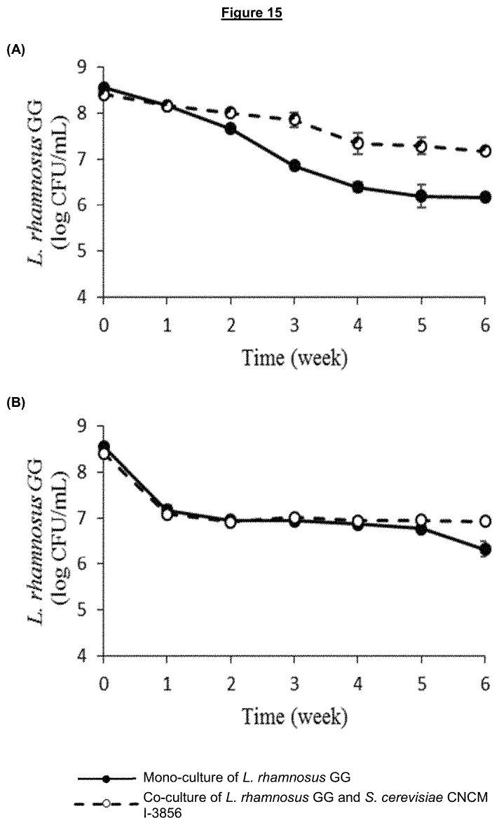

FIGS. 15, 16, and 17 show the weekly cell counts and pH results.

As seen in FIG. 15, at the beginning of shelf life, viable L. rhamnosus GG cell counts were 8.6 CFU/mL in mono-culture samples and 8.4 CFU/mL in co-culture samples. At 5° C. storage (FIG. 15(A)), significant reduction in L. rhamnosus GG cell counts were observed after 1 week of storage for both mono-culture and co-culture samples. Subsequently, decline in L. rhamnosus GG cell counts continued to be observed, with a steeper decline for mono-culture compared to co-culture samples. Significant differences in L. rhamnosus GG cell counts between mono-culture and co-culture samples started to be observed at week 2, with co-culture samples having 0.4 log CFU/mL higher in L. rhamnosus GG cell counts compared to mono-culture samples. At the end of the monitoring period (week 6), co-culture samples had 7.2 log CFU/mL of L. rhamnosus GG, which was 1.0 log CFU/mL higher than mono-culture samples (6.2 CFU/mL). At 30° C. storage (FIG. 15(B)), significant and sharp decline in L. rhamnosus GG cell counts were observed after 1 week of storage for both mono-culture and co-culture samples. Subsequently, L. rhamnosus GG cell counts stayed relatively stable for co-culture samples and gradually decreased for mono-culture samples. Significant differences in L. rhamnosus GG cell counts between mono-culture and co-culture samples started to be observed at week 5. At the end of the monitoring period (week 6), co-culture samples had 6.9 log CFU/mL of L. rhamnosus GG, which was 0.6 log CFU/mL higher than mono-culture samples (6.3 CFU/mL).

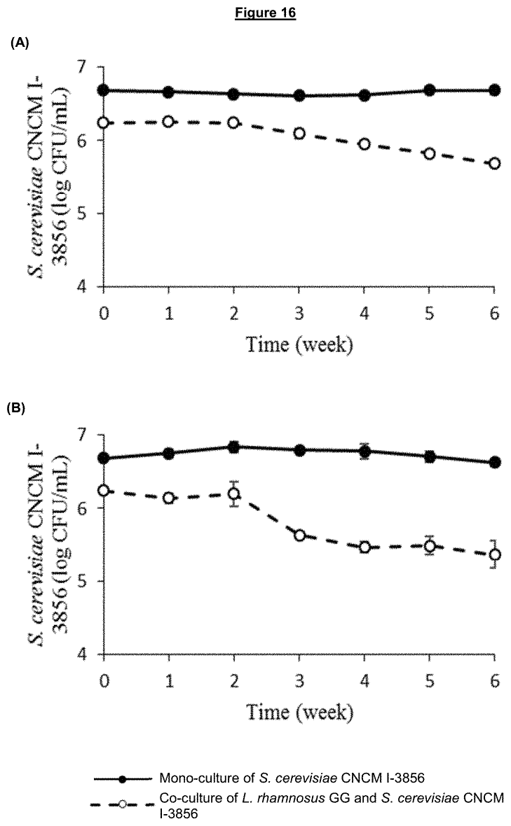

With regards to yeast cell counts, as seen in FIG. 16, at the beginning of shelf life, viable S. cerevisiae CNCM I-3856 cell counts were 6.7 CFU/mL in mono-culture samples and 6.3 CFU/mL in co-culture samples. At 5° C. storage (FIG. 16(A)), yeast cell counts stayed relatively stable for mono-culture samples. On the contrary, gradual reduction in yeast cell counts was observed in co-culture samples starting from week 3. At the end of the monitoring period (week 6), co-culture samples had 5.7 log CFU/mL of S. cerevisiae CNCM I-3856, which was 1.0 log CFU/mL lower than mono-culture samples (6.7 CFU/mL). At 30° C. storage (FIG. 16(B)), similar to 5° C. storage, yeast cell counts stayed relatively stable for mono-culture samples. On the contrary, sharp reduction in yeast cell counts was observed in co-culture samples at week 3, followed by gradual reduction. At the end of the monitoring period (week 6), co-culture samples had 5.4 log CFU/mL of S. cerevisiae CNCM I-3856, which was 1.2 log CFU/mL lower than mono-culture samples (6.6 CFU/mL).

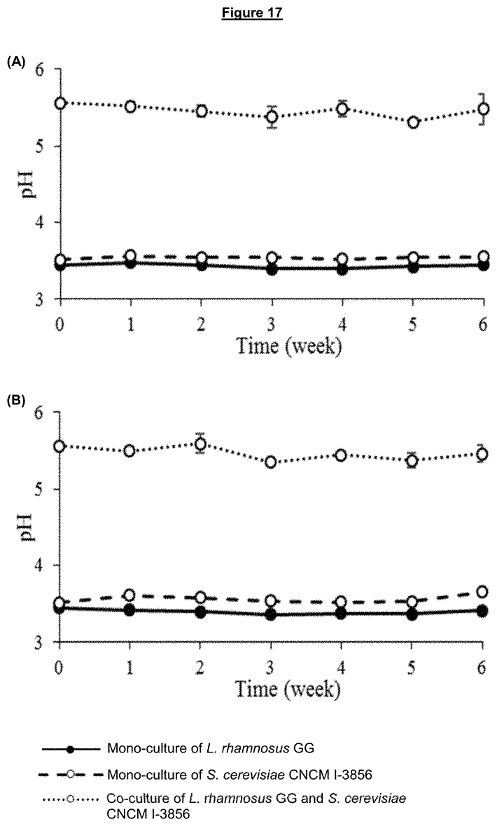

As seen in FIG. 17, the pH values of shelf life samples stayed relatively stable throughout storage at 5° C. (FIG. 17(A)) and at 30° C. (FIG. 17(B)). The pH values were around 3.4 for L. rhamnosus GG mono-culture samples, 5.5 for S. cerevisiae CNCM I-3856 mono-culture samples, and 3.6 for co-culture samples. No post-acidification occurred in the samples during storage.

Overall, reductions in cell counts during shelf life were observed in all samples. For L. rhamnosus GG, better viability was achieved in co-culture with S. cerevisiae CNCM I-3856, which helped maintained L. rhamnosus GG cell counts at 7 log CFU/mL after 6 weeks of storage at both 5° C. and 30° C. This might be due to protective and enhancing effects provided by the yeast cells. L. rhamnosus GG cell counts in mono-culture were less than 7 log CFU/mL after 6 weeks of storage at both 5° C. and 30° C. For S. cerevisiae CNCM I-3856, cell counts in mono-culture were relatively stable at 6.7 log CFU/mL at both storage temperatures. For co-culture, reductions to below 6 log CFU/mL after 6 weeks were observed at both storage temperatures.

(b) Quantification of Sugars and Organic Acids

Results from sugar and organic acid quantifications are presented in Table 3. From Table 3, unfermented bread slurry contained fructose, glucose, and maltose.

For S. cerevisiae CNCM I-3856 fermented samples, after fermentation at 37° C. for 16 hours, maltose and glucose were completely utilized in yeast-fermented samples as energy sources. Fructose was partially utilized during fermentation and completely consumed by the end of shelf life. It was noticeable that even though all maltose were utilized by yeast after 16 hours of fermentation, maltose was detected in S. cerevisiae CNCM I-3856 mono-culture samples after 6 weeks of storage at 5° C. This observation might be caused by other compounds eluting at the same retention time with maltose.

For L. rhamnosus GG-only fermented samples, after fermentation at 37° C. for 16 hours, glucose was exhausted, fructose was utilized partially, and maltose was not utilized. Complete utilization of maltose and fructose was observed at week 6 for 30° C. storage temperature.

For organic acids, oxalic, malic, acetic, fumaric and propionic acids were identified in unfermented bread slurry. Throughout fermentation and shelf life, no change in contents of oxalic acid and propionic acid was observed. Malic acid was utilized by both L. rhamnosus GG and yeast. Fumaric acid was utilized by L. rhamnosus GG. L. rhamnosus GG also produced lactic acid and acetic acid through glycolytic and phosphoketolase pathways, contributing to the low pH of L. rhamnosus GG fermented samples. During sample storage, there were slight increases in lactic acid for mono-culture samples and in acetic acid for both mono-culture and co-culture samples. However, as shown in FIG. 17, the increase was not coupled with significant reduction in pH of the samples. Increases in acetic acid were also observed in yeast mono-culture samples, possibly as a by-product of alcoholic fermentation. No post-acidification was observed during shelf life monitoring of yeast fermented samples even though there were slight in increases acetic acid contents.

TABLE 3
Sugar and organic acid contents in unfermented and
fermented bread slurries at beginning and end of shelf life.

| | | L. rhamnosus GG | | |
|---|---|---|---|---|
| | Unfermented | | Week 6 | Week 6 |
| Compounds | bread slurry | Week 0 | (5° C.) | (30° C.) |

Sugars (mg/mL)

| | | | | |
|---|---|---|---|---|
| Fructose | 3.21 ± 0.11^{b} | 0.85 ± 0.2^{a} | 0.61 ± 0.32^{a} | ND |
| Glucose | 2.46 ± 0.13 | ND | ND | ND |
| Maltose | 1.78 ± 0.07^{a} | 2.001 ± 0.22^{ab} | 2.23 ± 0.30^{ab} | ND |

Organic acids (mg/mL)

| Oxalic acid | 0.01 ± 0.00^{a} | 0.01 ± 0.00^{a} | 0.01 ± 0.00^{a} | 0.01 ± 0.00^{a} |
|---|---|---|---|---|
| Malic acid | 0.19 ± 0.03 | ND | ND | ND |
| Lactic acid | ND | 2.98 ± 0.20^{b} | 3.17 ± 023^{bc} | 3.33 ± 0.13^{c} |
| Acetic acid | 0.11 ± 0.02^{a} | 0.17 ± 0.02^{b} | 0.15 ± 0.02^{b} | 0.45 ± 0.02^{d} |
| Fumaric acid | 0.01 ± 0.00^{a} | ND | ND | ND |
| Propionic acid | 0.18 ± 0.02^{a} | 0.19 ± 0.02^{a} | 0.17 ± 0.03^{a} | 0.19 ± 0.00^{a} |
| | | S. cerevisiae CNCM I-3856 | | |
| | Unfermented | | Week 6 | Week 6 |
| Compounds | bread slurry | Week 0 | (5° C.) | (30° C.) |

Sugars (mg/mL)

| | | | | |
|---|---|---|---|---|
| Fructose | 3.21 ± 0.11^{b} | 0.62 ± 0.34^{a} | ND | ND |
| Glucose | 2.46 ± 0.13 | ND | ND | ND |
| Maltose | 1.78 ± 0.07^{a} | ND | 2.301 ± 0.33^{b} | ND |

Organic acids (mg/mL)

| Oxalic acid | 0.01 ± 0.00^{a} | 0.01 ± 0.00^{a} | 0.01 ± 0.00^{a} | 0.01 ± 0.00^{a} |
|---|---|---|---|---|
| Malic acid | 0.19 ± 0.03 | ND | ND | ND |
| Lactic acid | ND | ND | ND | ND |
| Acetic acid | 0.11 ± 0.02^{a} | 0.16 ± 0.05^{b} | 0.15 ± 0.03^{b} | 0.30 ± 0.00^{c} |
| Fumaric acid | 0.01 ± 0.00^{a} | 0.01 ± 0.00^{a} | 0.01 ± 0.00^{a} | 0.01 ± 0.00^{a} |
| Propionic acid | 0.18 ± 0.02^{a} | 0.18 ± 0.02^{a} | 0.17 ± 0.01^{a} | 0.18 ± 0.00^{a} |
| | | L. rhamnosus GG + S. cerevisiae CNCM I-3856 | | |
| | Unfermented | | Week 6 | Week 6 |
| Compounds | bread slurry | Week 0 | (5° C.) | (30° C.) |

Sugars (mg/mL)

| | | | | |
|---|---|---|---|---|
| Fructose | 3.21 ± 0.11^{b} | 0.48 ± 0.25^{a} | ND | ND |
| Glucose | 2.46 ± 0.13 | ND | ND | ND |
| Maltose | 1.78 ± 0.07^{a} | ND | ND | ND |

Organic acids (mg/mL)

| | | | | |
|---|---|---|---|---|
| Oxalic acid | 0.01 ± 0.00^{a} | 0.01 ± 0.00^{a} | 0.01 ± 0.00^{a} | 0.01 ± 0.00^{a} |
| Malic acid | 0.19 ± 0.03 | ND | ND | ND |
| Lactic acid | ND | 2.50 ± 0.15^{a} | 2.42 ± 0.16^{a} | 2.32 ± 0.41^{a} |
| Acetic acid | 0.11 ± 0.02^{a} | 0.15 ± 0.03^{b} | 0.15 ± 0.02^{b} | 0.30 ± 0.05^{c} |
| Fumaric acid | 0.01 ± 0.00^{a} | ND | ND | ND |
| Propionic acid | 0.18 ± 0.02^{a} | 0.17 ± 0.02^{a} | 0.17 ± 0.01^{a} | 0.18 ± 0.02^{a} |

Results reported as mean values and standard deviations from independent experiments (n = 3).
Mean values in the same row with different lowercase letters are significantly different (P < 0.05).
ND = Not detected.

(c) Quantification of Free Amino Acids (FAAs)

Results from free amino acid quantification are presented in Table 4. Results in Table 4 are reported as mean values and standard deviations from independent experiments (n=3). Mean values in the same row with different lowercase letters are significantly different (P<0.05).

As seen in Table 4, increase in overall FAAs contents was observed for L. rhamnosus GG fermented samples, as lactic acid bacteria can carry out proteolysis to produce the amino acids which are needed as their nutrient source. It is notable that there were increases in γ-aminobutyric acid (GABA) contents during shelf life of L. rhamnosus GG fermented samples to levels higher than unfermented samples, which might present nutritional benefits. In addition, increases in ammonia contents were also observed in L. rhamnosus GG fermented samples at 30° C. storage, which were likely produced by L. rhamnosus GG in response to acidic stress as ammonia is slightly basic. As opposed to L. rhamnosus GG fermented samples, reduction in FAAs contents was observed in yeast mono-culture samples after fermentation as yeast utilizes amino acids as nitrogen sources for biomass production. The FAAs contents slightly increased in samples stored at 30° C., which might be due to release of FAAs from yeast autolysis under stress conditions, de novo biosynthesis of amino acids, or release of amino acids from proteins by yeast proteases and peptidases.

(d) Quantification of Volatile Organic Compounds (VOCs)

Results from VOCs analysis are presented in Table 5. The results are reported as mean values and standard deviations from independent experiments (n=3). Column “LRI” refers to the experimental linear retention index determined on a DB-FFAP column relative to C10-C40 alkane standard. Lowercase letters indicate significant differences (P<0.05) in the same row (samples fermented with the same culture and unfermented bread slurry).

TABLE 4
FAAs contents in unfermented and fermented bread slurries at beginning and end of shelf life.

| | | L. rhamnosus GG | | |
|---|---|---|---|---|
| FAA | Unfermented | | Week 6 | Week 6 |
| (μg/mL) | bread slurry | Week 0 | (5° C.) | (30° C.) |
| Ammonia | 2.72 ± 0.19^{b} | 2.61 ± 0.52^{b} | 3.26 ± 0.46^{b} | 7.76 ± 0.66^{d} |
| Serine | 2.00 ± 0.53^{a} | 2.97 ± 0.14^{b} | 3.13 ± 0.16^{b} | 5.63 ± 0.28^{c} |
| Glutamic acid | 10.13 ± 0.47^{a} | 44.73 ± 6.66^{c} | 43.53 ± 6.49^{c} | 71.34 ± 8.50^{c} |
| Glycine | 2.04 ± 0.07^{b} | 2.23 ± 0.16^{b} | 2.47 ± 0.20^{bc} | 3.37 ± 0.19^{d} |
| Histidine | ND | ND | ND | 1.81 ± 0.20^{b} |
| Arginine | 3.51 ± 0.35^{b} | 4.97 ± 0.62^{cd} | 4.88 ± 0.23^{cd} | 5.40 ± 0.39^{d} |
| Threonine | 1.47 ± 0.04^{a} | ND | ND | ND |
| Alanine | 12.62 ± 0.33^{d} | 8.79 ± 0.27^{c} | 9.02 ± 0.47^{c} | 13.83 ± 0.70^{c} |
| Proline | 1.81 ± 0.14^{d} | 16.70 ± 2.22^{c} | 17.01 ± 2.70^{c} | 25.26 ± 2.85^{c} |
| Tyrosine | 2.29 ± 0.35^{a} | 3.29 ± 0.40^{ab} | 3.95 ± 0.70^{b} | 9.73 ± 0.85^{c} |
| Valine | 1.45 ± 0.61^{a} | ND | ND | 2.72 ± 0.21^{b} |
| Lysine | 2.92 ± 0.27^{b} | ND | ND | ND |
| Isoleucine | ND | ND | ND | 2.52 ± 0.33^{a} |
| Leucine | 2.83 ± 0.16^{ab} | 1.44 ± 0.20^{a} | 1.85 ± 0.25^{b} | 5.84 ± 0.76^{c} |
| Tryptophan | 5.10 ± 0.18^{d} | 4.38 ± 0.17^{c} | 4.76 ± 0.08^{cd} | ND |
| γ-ABA | 3.51 ± 0.35^{cd} | 2.54 ± 2.21^{abc} | 4.92 ± 0.46^{c} | 5.34 ± 0.74^{c} |
| | | S. cerevisiae CNCM I-3856 | | |
| FAA | Unfermented | | Week 6 | Week 6 |
| (μg/mL) | bread slurry | Week 0 | (5° C.) | (30° C.) |
| Ammonia | 2.72 ± 0.19^{b} | 1.28 ± 0.10^{a} | 1.10 ± 0.04^{a} | 0.94 ± 0.07^{a} |
| Serine | 2.00 ± 0.53^{a} | ND | ND | ND |
| Glutamic acid | 10.13 ± 0.47^{a} | 2.47 ± 0.82^{a} | 1.88 ± 0.35^{a} | 5.37 ± 1.66^{a} |
| Glycine | 2.04 ± 0.07^{b} | ND | ND | 1.56 ± 0.74^{a} |
| Histidine | ND | ND | ND | ND |
| Arginine | 3.51 ± 0.35^{b} | ND | ND | 2.04 ± 1.15^{a} |
| Threonine | 1.47 ± 0.04^{a} | ND | ND | ND |
| Alanine | 12.62 ± 0.33^{d} | ND | ND | 3.74 ± 0.62^{a} |
| Proline | 1.81 ± 0.14^{d} | ND | ND | 1.78 ± 0.15^{a} |
| Tyrosine | 2.29 ± 0.35^{a} | ND | ND | 2.82 ± 0.35^{ab} |
| Valine | 1.45 ± 0.61^{a} | ND | ND | 2.97 ± 0.17^{b} |
| Lysine | 2.92 ± 0.27^{b} | ND | ND | 2.38 ± 0.59^{a} |
| Isoleucine | ND | ND | ND | 2.94 ± 0.22^{a} |
| Leucine | 2.83 ± 0.16^{ab} | ND | ND | 3.64 ± 0.28^{b} |
| Tryptophan | 5.10 ± 0.18^{d} | ND | ND | ND |
| γ-ABA | 3.51 ± 0.35^{cd} | 1.67 ± 0.35^{ab} | 1.39 ± 0.21^{a} | 2.70 ± 0.15^{abc} |
| | | L. rhamnosus GG + S. cerevisiae CNCM I-3856 | | |
| FAA | Unfermented | | Week 6 | Week 6 |
| (μg/mL) | bread slurry | Week 0 | (5° C.) | (30° C.) |
| Ammonia | 2.72 ± 0.19^{b} | 1.49 ± 0.09^{a} | 1.59 ± 0.15^{a} | 6.93 ± 1.09^{c} |
| Serine | 2.00 ± 0.53^{a} | 2.61 ± 0.20^{b} | 2.61 ± 0.39^{b} | 6.67 ± 0.74^{d} |
| Glutamic acid | 10.13 ± 0.47^{a} | 19.02 ± 2.18^{b} | 19.06 ± 2.46^{b} | 47.96 ± 5.63^{c} |
| Glycine | 2.04 ± 0.07^{b} | 2.08 ± 0.09^{b} | 2.87 ± 0.09^{c} | 4.55 ± 0.28^{c} |
| Histidine | ND | ND | ND | 1.60 ± 0.17^{a} |
| Arginine | 3.51 ± 0.35^{b} | 2.32 ± 0.23^{a} | 2.40 ± 0.29^{a} | 4.36 ± 0.67^{bc} |
| Threonine | 1.47 ± 0.04^{a} | ND | ND | 3.90 ± 0.61^{b} |
| Alanine | 12.62 ± 0.33^{d} | 7.00 ± 0.66^{b} | 8.40 ± 0.77^{c} | 14.00 ± 0.70^{c} |
| Proline | 1.81 ± 0.14^{d} | 14.52 ± 1.06^{b} | 13.73 ± 1.35^{bc} | 21.30 ± 1.37^{d} |
| Tyrosine | 2.29 ± 0.35^{a} | ND | 2.63 ± 0.17^{ab} | 14.79 ± 2.09^{c} |
| Valine | 1.45 ± 0.61^{a} | ND | ND | 7.01 ± 0.52^{c} |
| Lysine | 2.92 ± 0.27^{b} | ND | ND | 2.16 ± 0.69^{a} |
| Isoleucine | ND | ND | ND | 6.46 ± 0.97^{b} |
| Leucine | 2.83 ± 0.16^{ab} | ND | 1.64 ± 0.18^{a} | 14.76 ± 2.23^{c} |
| Tryptophan | 5.10 ± 0.18^{d} | 2.32 ± 0.77^{a} | 3.20 ± 0.44^{b} | ND |
| γ-ABA | 3.51 ± 0.35^{cd} | 3.01 ± 0.45^{d} | 4.81 ± 0.24^{c} | 12.03 ± 0.17^{c} |

Key: ND = Not detected

TABLE 5
Selected volatile organic compounds (VOCs) in unfermented
and fermented bread slurries at beginning and end of shelf life.

| | | FID peak area × 10⁶ | | | |
|---|---|---|---|---|---|
| | | | L. rhamnosus GG | | |
| | | Unfermented | | Week 6 | Week 6 |
| Compounds | LRI | bread slurry | Week 0 | (5° C.) | (30° C.) |

Acids

| | | | | | |
|---|---|---|---|---|---|
| Acetic acid | 1450 | 0.28 ± 0.08^{a} | 6.55 ± 1.82^{b} | 5.90 ± 1.12^{b} | 34.29 ± 12.71^{c} |
| Propionic acid | 1532 | 4.54 ± 0.87^{a} | 60.07 ± 18.87^{b} | 43.43 ± 12.94^{b} | 97.52 ± 13.77^{c} |
| Isobutyric acid | 1561 | 0.28 ± 0.10^{a} | 0.29 ± 0.02^{a} | 0.32 ± 0.10^{a} | 0.19 ± 0.06^{a} |
| Butyric acid | 1622 | ND | 0.09 ± 0.01^{a} | 0.15 ± 0.08^{a} | 0.28 ± 0.07^{b} |

Alcohols

| | | | | | |
|---|---|---|---|---|---|
| Ethanol | — | 54.70 ± 8.33^{a} | 63.26 ± 21.53^{a} | 57.76 ± 7.43^{a} | 61.39 ± 12.00^{a} |
| Isobutyl alcohol | 1099 | 6.79 ± 0.56^{c} | 4.20 ± 1.05^{b} | 2.55 ± 0.60^{a} | 4.54 ± 0.29^{b} |
| Active Amyl alcohol | 1261 | 0.39 ± 0.15^{a} | 0.55 ± 0.06^{a} | 0.11 ± 0.02^{a} | 4.81 ± 1.10^{b} |
| 2-Ethyl-1-hexanol | 1504 | 0.14 ± 0.02^{a} | 0.33 ± 0.13^{b} | 0.22 ± 0.02^{ab} | 0.10 ± 0.01^{a} |
| Furfuryl alcohol | 1674 | ND | ND | ND | ND |
| Phenethyl alcohol | 1944 | ND | ND | ND | ND |

Ketones and Aldehydes

| | | | | | |
|---|---|---|---|---|---|
| Diacetyl | — | 8.83 ± 0.35^{a} | 13.12 ± 4.78^{a} | 12.04 ± 0.68^{a} | 12.67 ± 0.97^{a} |
| Hexanal | 1076 | 2.80 ± 0.89^{a} | 18.33 ± 4.14^{b} | 15.37 ± 5.42^{b} | 21.39 ± 6.58^{b} |
| 2-Heptanone | 1178 | 0.82 ± 0.20^{a} | 0.97 ± 0.34^{a} | 0.80 ± 0.39^{a} | 1.02 ± 0.20^{a} |
| 2-Octanone | 1278 | ND | 0.07 ± 0.03^{a} | 0.11 ± 0.02^{b} | 0.08 ± 0.02^{ab} |
| Acetoin | 1291 | 3.14 ± 0.39^{a} | 4.56 ± 1.58^{a} | 3.11 ± 0.13^{a} | 3.49 ± 0.69^{a} |
| 2-Octenal | 1428 | 0.36 ± 0.10^{a} | 0.23 ± 0.08^{a} | 0.44 ± 0.26^{a} | 0.30 ± 0.06^{a} |
| Furfural | 1471 | 0.11 ± 0.03^{b} | 0.08 ± 0.01^{b} | 0.08 ± 0.02^{b} | 0.04 ± 0.01^{a} |
| Butyrolactone | 1644 | ND | ND | ND | ND |

Esters

| Ethyl heptanoate | 1319 | ND | ND | ND | ND |
|---|---|---|---|---|---|
| Ethyl octanoate | 1425 | 0.37 ± 0.05^{a} | 0.40 ± 0.16^{a} | 0.33 ± 0.12^{a} | 0.81 ± 0.26^{b} |
| | | FID peak area × 10⁶ | | | |
| | | | S. cerevisiae CNCM I-3856 | | |
| | | Unfermented | | Week 6 | Week 6 |
| Compounds | LRI | bread slurry | Week 0 | (5° C.) | (30° C.) |

Acids

| | | | | | |
|---|---|---|---|---|---|
| Acetic acid | 1450 | 0.28 ± 0.08^{a} | 2.21 ± 0.25^{b} | 1.69 ± 0.48^{b} | 5.49 ± 1.44^{c} |
| Propionic acid | 1532 | 4.54 ± 0.87^{a} | 4.68 ± 0.52^{a} | 7.61 ± 1.90^{a} | 17.89 ± 7.34^{b} |
| Isobutyric acid | 1561 | 0.28 ± 0.10^{a} | 0.90 ± 0.19^{b} | 0.13 ± 0.02^{a} | 0.14 ± 0.03^{a} |
| Butyric acid | 1622 | ND | ND | ND | ND |

Alcohols

| | | | | | |
|---|---|---|---|---|---|
| Ethanol | — | 54.70 ± 8.33^{a} | 185.76 ± 91.85^{b} | 277.80 ± 36.77^{b} | 270.95 ± 47.42^{b} |
| Isobutyl alcohol | 1099 | 6.79 ± 0.56^{c} | 16.64 ± 4.93^{bc} | 18.30 ± 3.01^{c} | 11.42 ± 1.96^{ab} |
| Active Amyl alcohol | 1261 | 0.39 ± 0.15^{a} | ND | ND | ND |
| 2-Ethyl-1-hexanol | 1504 | 0.14 ± 0.02^{a} | ND | ND | ND |
| Furfuryl alcohol | 1674 | ND | 0.15 ± 0.02^{b} | 0.07 ± 0.02^{a} | 0.06 ± 0.00^{a} |
| Phenethyl alcohol | 1944 | ND | 6.42 ± 2.77^{a} | 13.36 ± 3.13^{b} | 14.32 ± 4.67^{b} |

Ketones and Aldehydes

| | | | | | |
|---|---|---|---|---|---|
| Diacetyl | — | 8.83 ± 0.35^{a} | ND | ND | ND |
| Hexanal | 1076 | 2.80 ± 0.89^{a} | ND | ND | ND |
| 2-Heptanone | 1178 | 0.82 ± 0.20^{a} | 0.82 ± 0.22^{b} | 0.47 ± 0.09^{a} | 0.48 ± 0.06^{a} |
| 2-Octanone | 1278 | ND | 0.26 ± 0.07^{b} | 0.13 ± 0.03^{a} | 0.11 ± 0.01^{a} |
| Acetoin | 1291 | 3.14 ± 0.39^{a} | 0.35 ± 0.10^{a} | 0.31 ± 0.10^{a} | 0.37 ± 0.08^{a} |
| 2-Octenal | 1428 | 0.36 ± 0.10^{a} | ND | ND | ND |
| Furfural | 1471 | 0.11 ± 0.03^{b} | ND | ND | ND |
| Butyrolactone | 1644 | ND | 0.05 ± 0.01^{a} | 0.34 ± 0.03^{b} | 0.40 ± 0.06^{b} |

Esters

| Ethyl heptanoate | 1319 | ND | ND | 0.05 ± 0.02^{a} | 0.06 ± 0.03^{a} |
|---|---|---|---|---|---|
| Ethyl octanoate | 1425 | 0.37 ± 0.05^{a} | 0.66 ± 021^{b} | 0.48 ± 0.08^{ab} | 0.35 ± 0.13^{a} |
| | | FID peak area × 10⁶ | | | |
| | | | L. rhamnosus GG + S. cerevisiae CNCM I-3856 | | |
| | | Unfermented | | Week 6 | Week 6 |
| Compounds | LRI | bread slurry | Week 0 | (5° C.) | (30° C.) |

Acids

| | | | | | |
|---|---|---|---|---|---|
| Acetic acid | 1450 | 0.28 ± 0.08^{a} | 4.20 ± 1.70^{b} | 5.48 ± 1.61^{b} | 21.86 ± 5.42^{c} |
| Propionic acid | 1532 | 4.54 ± 0.87^{a} | 71.02 ± 19.00^{c} | 84.38 ± 9.46^{c} | 47.95 ± 10.84^{b} |
| Isobutyric acid | 1561 | 0.28 ± 0.10^{a} | 0.30 ± 0.06^{a} | 0.32 ± 0.04^{a} | 0.85 ± 0.14^{b} |
| Butyric acid | 1622 | ND | 0.07 ± 0.02^{a} | 0.08 ± 0.02^{a} | 0.08 ± 0.02^{a} |

Alcohols

| | | | | | |
|---|---|---|---|---|---|
| Ethanol | — | 54.70 ± 8.33^{a} | 194.84 ± 17.26^{b} | 203.56 ± 23.17^{b} | 176.16 ± 28.56^{b} |
| Isobutyl alcohol | 1099 | 6.79 ± 0.56^{c} | 6.07 ± 1.03^{b} | 5.32 ± 0.78^{ab} | 4.47 ± 0.62^{a} |
| Active Amyl alcohol | 1261 | 0.39 ± 0.15^{a} | 0.41 ± 0.13^{a} | 0.43 ± 0.08^{a} | 0.43 ± 0.11^{a} |
| 2-Ethyl-1-hexanol | 1504 | 0.14 ± 0.02^{a} | 0.16 ± 0.03^{a} | 0.14 ± 0.03^{a} | 0.22 ± 0.03^{b} |
| Furfuryl alcohol | 1674 | ND | ND | ND | ND |
| Phenethyl alcohol | 1944 | ND | ND | ND | 19.75 ± 4.35 |

Ketones and Aldehydes

| | | | | | |
|---|---|---|---|---|---|
| Diacetyl | — | 8.83 ± 0.35^{a} | ND | ND | ND |
| Hexanal | 1076 | 2.80 ± 0.89^{a} | 15.76 ± 4.41^{b} | 17.36 ± 3.74^{b} | 22.03 ± 5.44^{b} |
| 2-Heptanone | 1178 | 0.82 ± 0.20^{a} | 0.76 ± 0.32^{a} | 1.24 ± 0.35^{a} | 0.97 ± 0.31^{a} |
| 2-Octanone | 1278 | ND | 0.04 ± 0.01^{a} | 0.04 ± 0.01^{a} | 0.03 ± 0.01^{a} |
| Acetoin | 1291 | 3.14 ± 0.39^{a} | 1.74 ± 0.35^{a} | 1.71 ± 0.34^{a} | 1.96 ± 0.32^{a} |
| 2-Octenal | 1428 | 0.36 ± 0.10^{a} | 0.24 ± 0.03^{ab} | 0.20 ± 0.04^{a} | 0.34 ± 0.07^{b} |
| Furfural | 1471 | 0.11 ± 0.03^{b} | 0.08 ± 0.00^{a} | 0.10 ± 0.01^{a} | 0.08 ± 0.03^{a} |
| Butyrolactone | 1644 | ND | ND | ND | ND |

Esters

| | | | | | |
|---|---|---|---|---|---|
| Ethyl heptanoate | 1319 | ND | ND | ND | ND |
| Ethyl octanoate | 1425 | 0.37 ± 0.05^{a} | 0.43 ± 0.06^{b} | 0.37 ± 0.03^{b} | 0.24 ± 0.05^{a} |

Key: ND = Not detected

Regarding VOCs (Table 5), for acids, FID peak areas indicated increases in acetic acid from fermentation and during shelf life, which corresponded with high-performance liquid chromatography (HPLC) analysis (Table 3). Increases in propionic acid were also observed from fermentaion and during shelf life. This was not observed in HPLC analysis which indicated no change in propionic acid contents. It was possible that the observed increases in GC/FID peak areas for propionic acid were caused by co-eluting of peaks representing other compounds. Production of butyric acid by L. rhamnosus GG was observed, which was not detected by HPLC analysis, likely because the concentrations of butyric acid in samples were below the limit of detection for HPLC analysis.

For alcohols, endogenous ethanol was detected in unfermented bread slurry, likely as residual ethanol from bread making. Significant ethanol production was observed in yeast fermented samples. Yeast-only fermented samples were also observed with production of Ehrlich pathway's alcohols such as isobutyl alcohol and 2-phenethyl alcohol. On the other hand, L. rhamnosus GG (both mono-culture and co-culture), were observed with more ketones and aldehydes production than yeast-only fermented samples.

(e) Quantification of Ethanol Contents

Results from quantification of ethanol contents are presented in Table 6.

TABLE 6
Ethanol contents in unfermented and fermented bread slurries
at beginning and end of shelf life.
Ethanol content (%)

| | | | | L. rhamnosus |
|---|---|---|---|---|
| | | | S. cerevisiae | GG + |
| | Unfermented | L. rhamnosus | CNCM | S. cerevisiae |
| | bread slurry | GG | I-3856 | CNCM I-3856 |
| Week 0 | 0.09 ± 0.02^{a} | 0.11 ± 0.02^{a} | 0.30 ± 0.02^{b} | 0.25 ± 0.01^{b} |
| Week 6 | — | 0.09 ± 0.01^{a} | 0.24 ± 0.03^{b} | 0.22 ± 0.02^{b} |
| (5° C.) | | | | |
| Week 6 | — | 0.10 ± 0.02^{a} | 0.27 ± 0.03^{c} | 0.22 ± 0.02^{b} |
| (30° C.) | | | | |

Results reported as mean values and standard deviations from independent experiments (n = 3).
Mean values in the same row with different lowercase letters are significantly different (P < 0.05).
“—” indicates data were not collected.

From Table 6, production of ethanol was observed in yeast fermented samples. However, all sample could be considered non-alcoholic with ethanol contents less than 0.5%. Nevertheless, the ethanol contents of bread-based yeast-fermented beverages can be easily adjusted through the addition of sugars.

### Example 8—Shelf Life Study (13 Weeks, on Bread-Based Beverages Fermented with L. rhamnosus GG and/or S. cerevisiae CNCM I-3856)

In this example, shelf life monitoring for a duration of 13 weeks was carried out at 5° C. and 30° C. storage for bread-based fermented beverages made with 5.00 wt. % solid Gardenia Enriched White Bread. Samples were inoculated with either L. rhamnosus GG mono-culture, S. cerevisiae CNCM I-3856 mono-culture, or co-culture of the two aforementioned strains, and incubated at 37° C. for 16 hours before being transferred to storage.

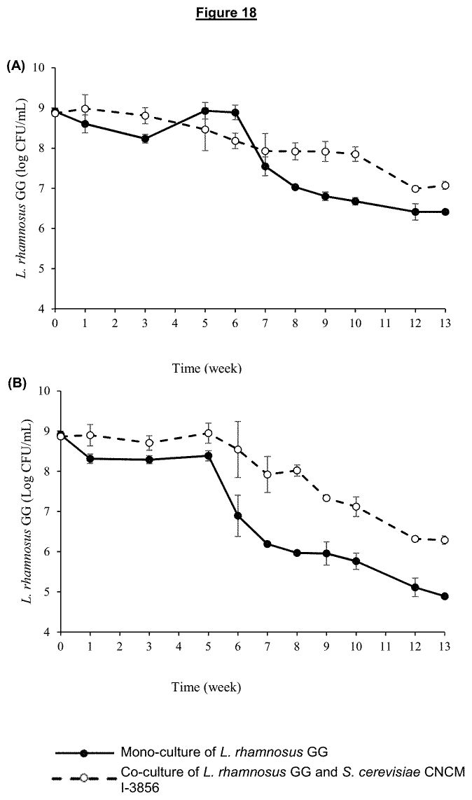

FIGS. 18, 19, and 20 show the weekly cell counts and pH results.

As shown in FIG. 18, at the beginning of shelf life, viable L. rhamnosus GG cell counts were 8.9 CFU/mL in both mono-culture samples and co-culture samples. As seen in FIG. 18(A), at 5° C. storage, there was significant reduction in L. rhamnosus GG cell counts over the storage duration for both mono-culture and co-culture samples.

At the end of the monitoring period (week 13), co-culture samples had 7.1 log CFU/mL of L. rhamnosus GG, which was 0.7 log CFU/mL higher than mono-culture samples (6.4 CFU/mL). As seen in FIG. 18(B), at 30° C. storage, there was a higher extent of decline in L. rhamnosus GG cell counts over the storage duration as compared to 5° C. storage. At the end of the monitoring period (week 13), co-culture samples had 6.3 log CFU/mL of L. rhamnosus GG, which was 1.4 log CFU/mL higher than mono-culture samples (4.9 CFU/mL).

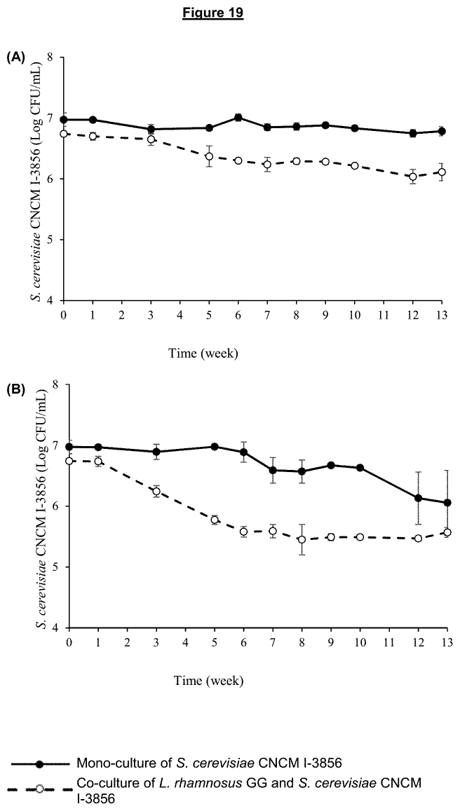

With regards to yeast cell counts, FIG. 19 shows that at the beginning of shelf life, viable S. cerevisiae CNCM I-3856 cell counts were 7.0 CFU/mL in mono-culture samples and 6.7 CFU/mL in co-culture samples. As seen in FIG. 19(A), at 5° C. storage, yeast cell counts stayed relatively stable for mono-culture samples. On the contrary, gradual reduction in yeast cell counts was observed in co-culture samples. At the end of the monitoring period (week 13), co-culture samples had 6.1 log CFU/mL of S. cerevisiae CNCM I-3856, which was 0.7 log CFU/mL lower than mono-culture samples (6.8 CFU/mL). As seen in FIG. 19(B), at 30° C. storage, there were reduction in yeast cell counts for both mono-culture samples and co-culture samples. At the end of the monitoring period (week 13), co-culture samples had 5.6 log CFU/mL of S. cerevisiae CNCM I-3856, which was 0.5 log CFU/mL lower than mono-culture samples (6.1 CFU/mL).

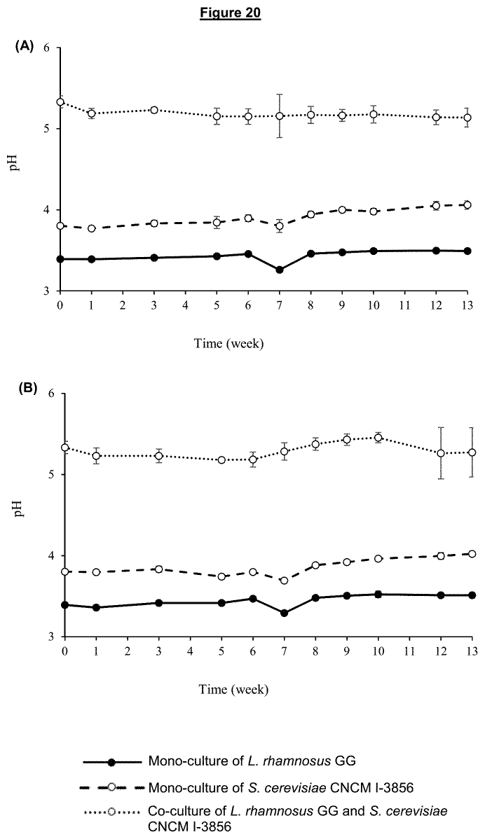

As shown in FIG. 20, the pH values of shelf life samples stayed relatively stable throughout storage at 5° C. (FIG. 20 (A)) and at 30° C. (FIG. 20(B)). The pH values were around 3.4 for L. rhamnosus GG mono-culture samples, 5.2 for S. cerevisiae CNCM I-3856 mono-culture samples, and 3.9 for co-culture samples. No post-acidification occurred in the samples during storage.

Overall, observations on cell counts throughout storage durations showed similar trends to Example 7. Reductions in cell counts during shelf life were observed in all samples. At the end of 13 weeks, probiotic cell counts in samples were lower compared to at the end of 6 weeks. For L. rhamnosus GG, better viability was achieved in co-culture with S. cerevisiae CNCM I-3856 storage at both 5° C. and 30° C. L. rhamnosus GG cell count of 7 log CFU/mL in co-culture samples was maintained for at least 13 weeks at 5° C. and up to 10 weeks at 30° C. For S. cerevisiae CNCM I-3856, better viability was achieved in mono-culture compared to co-culture, likely due to lower pH in co-culture samples causing damage to S. cerevisiae CNCM I-3856 cells.

### Example 9—Shelf Life Study (12 Weeks, on Bread-Based Beverages Fermented with B. lactis BB-12, and with or without S. cerevisiae CNCM I-3856)

Shelf life monitoring for a duration of 12 weeks was carried out at 5° C. and 30° C. storage for bread-based fermented beverages made with 5.00 wt. % solid Gardenia Enriched White Bread. Samples were inoculated with either B. lactis BB-12 mono-culture, or co-culture of B. lactis BB-12 and S. cerevisiae CNCM I-3856, and incubated at 37° C. for 24 hours before being transferred to storage.

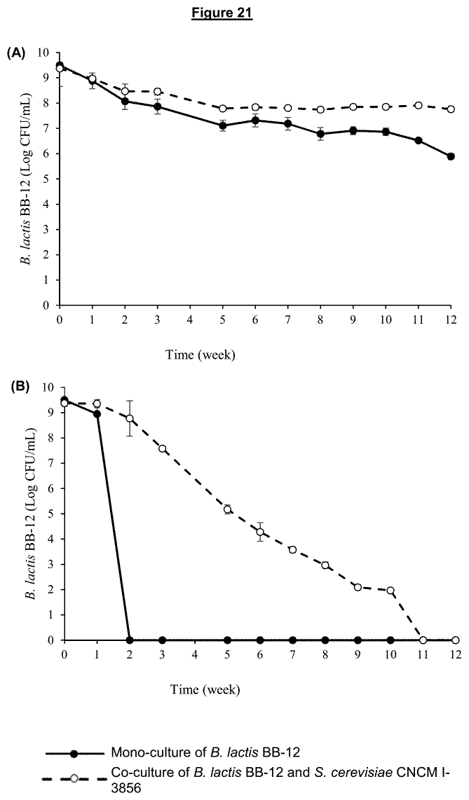

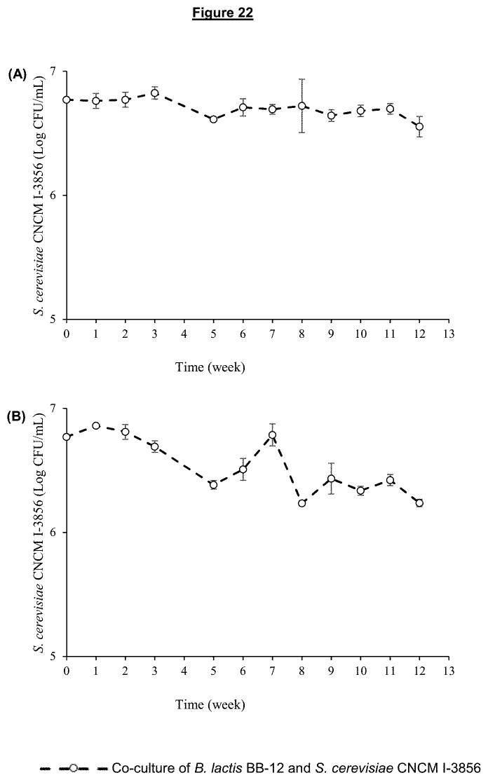

FIGS. 21 and 22 show weekly cell counts.

As seen in FIG. 21, at the beginning of shelf life, viable B. lactis BB-12 cell counts were 9.5 CFU/mL in mono-culture samples and 9.4 CFU/mL in co-culture samples. As seen in FIG. 21(A), at 5° C. storage, gradual reduction in B. lactis BB-12 cell counts were observed over storage duration for both mono-culture and co-culture samples. At the end of the monitoring period (week 12), co-culture samples had 7.8 log CFU/mL of B. lactis BB-12, which was 1.9 log CFU/mL higher than mono-culture samples (5.9 CFU/mL). As seen in FIG. 21(B), at 30° C. storage, a much sharper decline in B. lactis BB-12 cell counts were observed over storage duration as compared to 5° C. storage. At 30° C. storage, no viable BB-12 cell counts were detected after 11 weeks in co-culture samples and after 2 weeks in mono-culture samples.

With regards to yeast cell counts, FIG. 22 shows that at the beginning of shelf life, viable S. cerevisiae CNCM I-3856 cell counts were 6.8 CFU/mL in co-culture samples. As seen in FIG. 22(A), at 5° C. storage, yeast cell counts stayed relatively stable. At the end of the monitoring period (week 12), co-culture samples had 6.6 log CFU/mL of S. cerevisiae CNCM I-3856. As seen in FIG. 22(B), at 30° C. storage, yeast cells was observed with less stability compared to 5° C. storage. At the end of the monitoring period (week 12), co-culture samples had 6.2 log CFU/mL of S. cerevisiae CNCM I-3856

The pH values of shelf life samples stayed relatively stable throughout storage at around 4.1 for B. lactis BB-12 mono-culture samples, and 4.5 for co-culture samples.

Overall, compared to L. rhamnosus GG, the strain B. lactis BB-12 is not as stable at 30° C. storage, while good stability is still observed at 5° C. storage. Similar to L. rhamnosus GG, the strain B. lactis BB-12 also demonstrated better viability in co-culture with S. cerevisiae CNCM I-3856. Viable B. lactis BB-12 cell counts of more than 7 CFU/mL can be maintained for at least 12 weeks of storage at 5° C. storage in co-culture with S. cerevisiae CNCM I-3856.

Whilst the foregoing description has described exemplary embodiments, it will be understood by those skilled in the technology concerned that many variations may be made without departing from the present invention.

1. A bread-based beverage comprising probiotics, wherein the probiotics has a live probiotic cell count of ≥5.0 log CFU/mL.

2. The beverage according to claim 1, wherein after 6 weeks of storage, the probiotics comprised in the beverage has a live probiotic cell count of ≥5.0 log CFU/mL.

3. The beverage according to claim 1, wherein the beverage is a fermented beverage.

4. The beverage according to claim 1, wherein the probiotics comprises: a probiotic yeast, a probiotic bacteria, or a combination thereof.

5. The beverage according to claim 1, wherein the probiotics comprises: lactobacilli, bifidobacteria, Saccharomyces yeast, or a combination thereof.

6. The beverage according to claim 4, wherein the probiotics comprises: Lactobacillus (Lb.) rhamnosus, Saccharomyces (S.) cerevisiae, Bifidobacterium (B.) lactis, or a combination thereof.

7. (canceled)

8. (canceled)

9. A method of preparing a bread-based beverage comprising probiotics having a live cell count of ≥5.0 log CFU/mL, the method comprising:
mixing bread with water to form a mixture;
adding probiotics to the mixture to form an inoculated mixture; and
fermenting the inoculated mixture to form the beverage.

10. The method according to claim 9, wherein the method is a zero-waste method.

11. The method according to claim 9, wherein the mixing comprises homogenising the mixture.

12. The method according to claim 9, wherein concentration of bread in the mixture is 0.5-10.0 wt % based on total solid content of the mixture.

13. The method according to claim 9, wherein the bread has moisture content of 30-45 wt %.

14. The method according to claim 9, wherein the probiotics comprises: a probiotic yeast, a probiotic bacteria, or a combination thereof.

15. The method according to claim 9, wherein the probiotics comprises: lactobacilli, bifidobacteria, Saccharomyces yeast, or a combination thereof.

16. The method according to claim 15, wherein the probiotics comprises: Lactobacillus (Lb.) rhamnosus, Saccharomyces (S.) cerevisiae, Bifidobacterium (B.) lactis, or a combination thereof.

17. The method according to claim 9, wherein the adding comprises adding probiotics to obtain an initial probiotic live count of at least 1 log CFU/mL.

18. The method according to claim 9, wherein the fermenting is for a pre-determined period of time of 4-96 hours.

19. The method according to claim 9, wherein the fermenting is at a predetermined temperature of 15-45° C.

20. The method according to claim 9, further comprising adding an additive to the mixture.

21. (canceled)

22. The method according to claim 9, further comprising heat-treating the mixture prior to the adding probiotics.

23. The method according to claim 22, further comprising cooling the mixture following the heat treating and prior to the adding probiotics.
